(19) United States
(12) Patent Application Publication
(10) Pub. No.: US 2009/0316172 A1
(43) Pub. Date: Dec. 24, 2009

(54) IMAGE READING APPARATUS AND IMAGE FORMING APPARATUS

(75) Inventor: Koji Tanimoto, Tagata-gun (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/485,123

(22) Filed: Jun. 16, 2009

Related U.S. Application Data
(60) Provisional application No. 61/073,997, filed on Jun. 19, 2008.

(51) Int. Cl. G06F 15/00; H04N 1/46

(52) U.S. Cl. 358/1.9; 358/512

(57) ABSTRACT

An image reading apparatus includes a color line sensor that converts an image of an original document into an electric signal at first resolution and a monochrome line sensor that converts the image of the original document into an electric signal at second resolution higher than the first resolution. The image reading apparatus further includes an image-quality improving circuit that calculates a correlation between first image data obtained by reading the image of the original document at the first resolution with the color line sensor and second image data obtained by reading the image of the original document at the second resolution with the monochrome line sensor and converts the first image data into third image data having resolution higher than the first resolution on the basis of the calculated correlation.

### CROSS-REFERENCE TO RELATED APPLICATION

This application claims the benefit of U.S. Provisional Application No. 61/073,997, filed Jun. 19, 2008.

### TECHNICAL FIELD

The present invention relates to an image reading apparatus such as an image scanner that reads an image and an image forming apparatus having a copying function for forming the image read by the image reading apparatus on an image forming medium.

### BACKGROUND

There is an image reading apparatus including sensors having different resolutions. The image reading apparatus reads an image of an original document as plural image data having different resolutions. In general, when a color sensor and a monochrome (luminance) sensor are compared, the monochrome (luminance) sensor has higher sensitivity. This is because, whereas the color sensor detects light through an optical filter that transmits only light in a wavelength range corresponding to a desired color, the monochrome (luminance) sensor detects light in a wavelength range wider than that of the color sensor. Therefore, the monochrome (luminance) sensor obtains a signal of a level equivalent to that of the color sensor even if a physical size thereof is smaller than that of the color sensor. In an image reading apparatus including both the color sensor and the monochrome (luminance) sensor, the resolution of the monochrome (luminance) sensor is higher than the resolution of the color sensor because of the difference in sensitivity of the sensors explained above.

As image processing used in the image reading apparatus including the sensors having different resolutions, there is processing for increasing the resolution of image data having low resolution using image data having high resolution. For example, JP-A-2007-73046 discloses a method of increasing the resolution of color image data. However, in the technology disclosed in JP-A-2007-73046, when the resolution of color signals is increased, the color signals change in a fixed direction and chroma falls.

### SUMMARY

It is an object of an aspect of the prevent invention to provide an image reading apparatus and an image forming apparatus that improve a quality of second image data read by a second sensor using first image data read by a first sensor.

According to an aspect of the present invention, there is provided an image reading apparatus including: a first photoelectric conversion unit that converts an image of an original document into an electric signal at first resolution; a second photoelectric conversion unit that converts the image of the original document into an electric signal at second resolution higher than the first resolution; and an image-quality improving unit that is input with first image data obtained by reading the image of the original document at the first resolution with the first photoelectric conversion unit and second image data obtained by reading the image of the original document at the second resolution with the second photoelectric conversion unit, outputs, if a correlation between the first image data and the second image data is positive correlation, third image data obtained by converting the first resolution of the first image data into the second resolution and having positive correlation as a correlation with the first image data, and outputs, if the correlation between the first image data and the second image data is negative correlation, third image data obtained by converting the first resolution of the first image data into the second resolution and having negative correlation as a correlation with the first image data.

According to another aspect of the present invention, there is provided an image reading apparatus including: a first photoelectric conversion unit that has sensitivity to a first wavelength range; a second photoelectric conversion unit that has sensitivity to a wavelength range including the first wavelength range and wider than the first wavelength range; and an image-quality improving unit that is input with first image data obtained by reading an image of an original document with the first photoelectric conversion unit and second image data obtained by reading the image of the original document with the second photoelectric conversion unit, outputs, if a correlation between the first image data and the second image data is positive correlation, third image data having positive correlation as a correlation with the first image data, and outputs, if the correlation between the first image data and the second image data is negative correlation, third image data having negative correlation as a correlation with the first image data.

According to still another aspect of the present invention, there is provided an image forming apparatus including: a first photoelectric conversion unit that converts an image of an original document into an electric signal at first resolution; a second photoelectric conversion unit that converts the image of the original document into an electric signal at second resolution higher than the first resolution; an image-quality improving unit that is input with first image data obtained by reading the image of the original document at the first resolution with the first photoelectric conversion unit and second image data obtained by reading the image of the original document at the second resolution with the second photoelectric conversion unit, outputs, if a correlation between the first image data and the second image data is positive correlation, third image data obtained by converting the first resolution of the first image data into the second resolution and having positive correlation as a correlation with the first image data, and outputs, if the correlation between the first image data and the second image data is negative correlation, third image data obtained by converting the first resolution of the first image data into the second resolution and having negative correlation as a correlation with the first image data; and an image forming unit that forms third image data generated by the image-quality improving unit on an image forming medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of an internal configuration example of a color digital multi function peripheral;

FIG. 2 is a block diagram of a configuration example of a control system in the digital multi function peripheral;

FIG. 3A is an external view of a four-line CCD sensor as a photoelectric conversion unit;

FIG. 3B is a diagram of a configuration example in the photoelectric conversion unit;

FIG. 4 is a graph of spectral sensitivity characteristics of three color line sensors;

FIG. 5 is a graph of a spectral sensitivity characteristic of a monochrome line sensor;

FIG. 6 is a graph of a spectral distribution of a xenon lamp used as a light source;

FIG. 7A is a timing chart of the operation of the line sensors shown in FIGS. 3A and 3B and various signals;

FIG. 7B is a diagram of an output signal of the monochrome line sensor;

FIG. 7C is a diagram of an output signal of the color line sensors;

FIG. 8 is a diagram of a configuration example of a scanner-image processing unit that processes a signal from the photoelectric conversion unit;

FIG. 9 is a diagram of pixels read by the monochrome line sensor;

FIG. 10 is a diagram of pixels read by the color line sensors in a range same as that shown in FIG. 9;

FIG. 11 is a diagram of output values of the sensors shown as a graph (a profile);

FIG. 12 is a diagram of a profile of luminance data equivalent to 300 dpi shown as a graph;

FIG. 13 is a table of output values corresponding to a cyan solid image, a magenta solid image, and an image including a boundary;

FIG. 14 is a scatter diagram with luminance data plotted on the abscissa and values of color data plotted on the ordinate;

FIG. 15 is a graph of color data equivalent to 600 dpi generated on the basis of a correlation shown in FIG. 14;

FIG. 16 is a block diagram of processing in an image-quality improving circuit;

FIG. 17 is a diagram of a profile of image data obtained when an image including a frequency component in which moiré occurs at 300 dpi is read at resolution of 600 dpi;

FIG. 18 is a diagram of a profile of image data obtained when the image data shown in FIG. 17 is converted into 300 dpi image data;

FIG. 19 is a block diagram of a configuration example of a second image-quality improving circuit;

FIG. 20 is a table of determination contents corresponding to combinations of standard deviations with respect to a pixel value of 600 dpi and standard deviations with respect to a pixel value of 300 dpi;

FIG. 21 is a block diagram of a configuration example of a second resolution improving circuit;

FIG. 22 is a diagram of an example of 600 dpi luminance (monochrome) data forming a 2×2 pixel matrix;

FIG. 23 is a diagram of an example of 300 dpi monochrome data (color data) corresponding to the 2×2 pixel matrix shown in FIG. 22;

FIG. 24 is a diagram of superimposition rates in 600 dpi pixels;

FIG. 25A is a diagram of an example of 300 dpi R data (R300);

FIG. 25B is a diagram of an example of 300 dpi G data (G300);

FIG. 25C is a diagram of an example of 300 dpi B data (B300);

FIG. 26A is a diagram of an example of R data (R600) equivalent to 600 dpi generated from the 300 dpi R data shown in FIG. 25A;

FIG. 26B is a diagram of an example of G data (G600) equivalent to 600 dpi generated from the 300 dpi G data shown in FIG. 25B;

FIG. 26C is a diagram of B data (B600) equivalent to 600 dpi generated from the 300 dpi B data shown in FIG. 25C; and

FIG. 27 is a diagram for explaining image-quality improving processing for securing continuity among adjacent pixels.

### DETAILED DESCRIPTION

An embodiment of the present invention is explained below in detail with reference to the accompanying drawings.

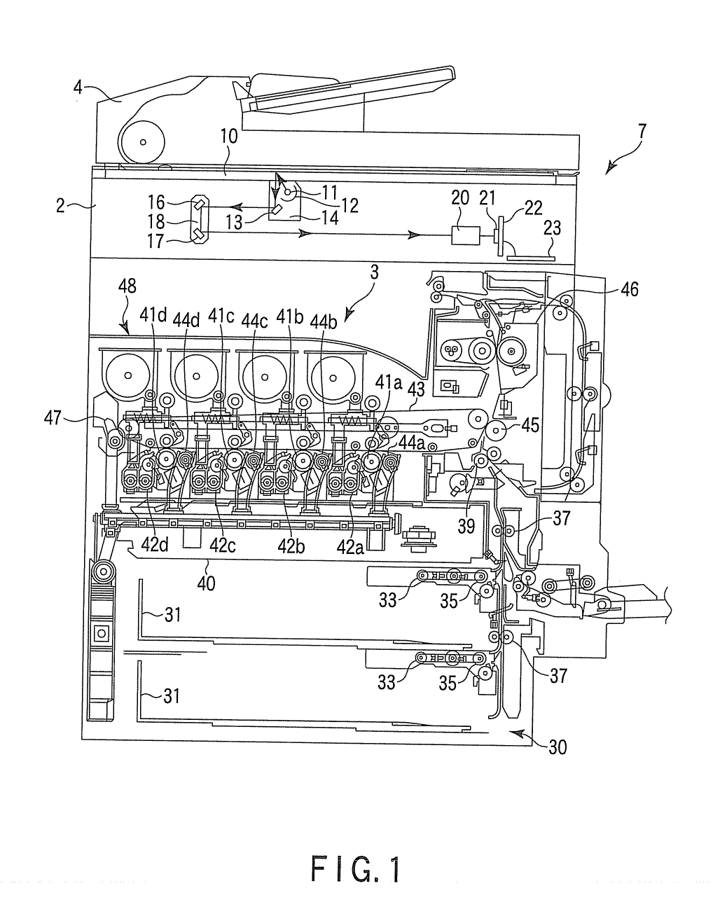

FIG. 1 is a sectional view of an internal configuration example of a color digital multi function peripheral 1.

The digital multi function peripheral 1 shown in FIG. 1 includes an image reading unit (a scanner) 2, an image forming unit (a printer) 3, an auto document feeder (ADF) 4, and an operation unit (a control panel (not shown in FIG. 1)). The image reading unit 2 optically scans the surface of an original document to thereby read an image on the original document as color image data (multi-value image data) or monochrome image data. The image forming unit 3 forms an image based on the color image data (the multi-value image data) or the monochrome image data on a sheet. The ADF 4 conveys original documents set on a document placing unit one by one. The ADF 4 conveys the original document at predetermined speed to allow the image reading unit 2 to read an image formed on the surface of the original document. The operation unit receives the input of an operation instruction from a user and displays guidance for the user.

The digital multi function peripheral 1 includes various external interfaces for inputting and outputting image data. For example, the digital multi function peripheral 1 includes a facsimile interface for transmitting and receiving facsimile data and a network interface for performing network communication. With such a configuration, the digital multi function peripheral 1 functions as a copy machine, a scanner, a printer, a facsimile, and a network communication machine.

A configuration of the image reading unit 2 is explained.

The image reading unit 2 includes, as shown in FIG. 1, the ADF 4, a document table glass 10, a light source 11, a reflector 12, a first mirror 13, a first carriage 14, a second mirror 16, a third mirror 17, a second carriage 18, a condensing lens 20, a photoelectric conversion unit 21, a CCD board 22, and a CCD control board 23.

The ADF 4 is provided above the image reading unit 2. The ADF 4 includes the document placing unit that hold plural original documents. The ADF 4 conveys the original documents set in the original placing unit one by one. The ADF 4 conveys the original document at fixed conveying speed to allow the image reading unit 2 to read an image formed on the surface of the original document.

The document table glass 10 is glass that holds an original document. Reflected light from the surface of the original document held on the document table glass 10 is transmitted through the glass. The ADF 4 covers the entire document table glass 10. The ADF 4 closely attaches the original document on the document table glass 10 to a glass surface and fixes the original document. The ADF 4 also functions as a background for the original document on the document table glass 10.

The light source 11 exposes the surface of the original document placed on the document table glass 10. The light source 11 is, for example, a fluorescent lamp, a xenon lamp, or a halogen lamp. The reflector 12 is a member that adjusts a distribution of light from the light source 11. The first mirror 13 leads light from the surface of the original document to the second mirror 16. The first carriage 14 is mounted with the light source 11, the reflector 12, and the first mirror 13. The first carriage 14 moves at speed (V) in a sub-scanning direction with respect to the surface of the original document on the document table glass 10 with driving force given from a not-shown driving unit.

The second mirror 16 and the third mirror 17 lead the light from the first mirror 13 to the condensing lens 20. The second carriage 18 is mounted with the second mirror 16 and the third mirror 17. The second carriage 18 moves in the sub-scanning direction at half speed (V/2) of the speed (V) of the first carriage 14. In order to keep a distance from a reading position on the surface of the original document to a light receiving surface of the photoelectric conversion unit 21 at fixed optical path length, the second carriage 18 follows the first carriage 14 at half speed of the speed of the first carriage.

The light from the surface of the original document is made incident on the condensing lens 20 via the first, second, and third mirrors 13, 16, and 17. The condensing lens 20 leads the incident light to the photoelectric conversion unit 21 that converts the light into an electric signal. The reflected light from the surface of the original document is transmitted through the glass of the document table glass 10, sequentially reflected by the first mirror 13, the second mirror 16, and the third mirror 17, and focused on the light receiving surface of the photoelectric conversion unit 21 via the condensing lens 20.

The photoelectric conversion unit 21 includes plural line sensors. The line sensors of the photoelectric conversion unit 21 have a configuration in which plural photoelectric conversion elements that convert light into an electric signal are arranged in a main scanning direction. The line sensors are arranged side by side in parallel such that the line sensors are arranged at specified intervals in the sub-scanning direction.

In this embodiment, the photoelectric conversion unit 21 includes four line CCD sensors. As explained later, the four line CCD sensors as the photoelectric conversion unit 21 include one monochrome line sensor 61K and three color line sensors 61R, 61G, and 61B. The monochrome line sensor 61K reads black image data. The three color line sensors 61R, 61G, and 61B read color image data of three colors, respectively. When a color image is read with three colors of R (red), G (green), and B (blue), color line sensors include the red line sensor 61R that reads a red image, the green line sensor 61G that reads a green image, and the blue line sensor 61B that reads a blue image.

The CCD board 22 is mounted with a sensor driving circuit (not shown in the figure) for driving the photoelectric conversion unit 21. The CCD control board 23 controls the CCD board 22 and the photoelectric conversion unit 21. The CCD control board 23 includes a control circuit (not shown in the figure) that controls the CCD board 22 and the photoelectric conversion unit 21 and an image processing circuit (not shown in the figure) that processes an image signal from the photoelectric conversion unit 21.

A configuration of the image forming unit 3 is explained.

As shown in FIG. 1, the image forming unit 3 includes a sheet feeding unit 30, an exposing device 40, first to fourth photoconductive drums 41a to 41d, first to fourth developing devices 42a to 42d, a transfer belt 43, cleaners 44a to 44d, a transfer device 45, a fixing device 46, a belt cleaner 47, and a stock unit 48.

The exposing device 40 forms latent images on the first to fourth photoconductive drums 41a to 41d. The exposing device 40 irradiates exposure light corresponding to image data on the photoconductive drums 41a to 41d functioning as image bearing members for the respective colors. The first to fourth photoconductive drums 41a to 41d carry electrostatic latent images. The photoconductive drums 41a to 41d form electrostatic latent images corresponding to the intensity of the exposure light irradiated from the exposing device 40.

The first to fourth developing devices 42a to 42d develop the latent images carried by the photoconductive drums 41a to 41d with the respective colors. Specifically, the developing devices 42a to 42d supply toners of the respective colors to the latent images carried by the photoconductive drums 41a to 41d corresponding thereto to thereby develop the images. For example, the image forming unit is configured to obtain a color image according to subtractive color mixture of the three colors, cyan, magenta, and yellow. In this case, the first to fourth developing devices 42a to 42d visualize (develop) the latent images carried by the photoconductive drums 41a to 41d with any ones of the colors, yellow, magenta, cyan, and black. The first to fourth developing devices 42a to 42d store toners of any ones of the colors, yellow, magenta, cyan, and black, respectively. The toners of the colors stored in the respective first to fourth developing devices 42a to 42d (order for developing of images of the respective colors) are determined according to an image forming process or characteristics of the toners.

The transfer belt 43 functions as an intermediate transfer member. Toner images of the colors formed on the photoconductive drums 41a to 41d are transferred onto the transfer belt 43 functioning as the intermediate transfer member in order. The photoconductive drums 41a to 41d transfer, in an intermediate transfer position, the toner images on drum surfaces thereof onto the transfer belt 43 with intermediate transfer voltage. The transfer belt 43 carries a color toner image formed by superimposing the images of the four colors (yellow, magenta, cyan, and black) transferred by the photoconductive drums 41a to 41d. The transfer device 45 transfers the toner image formed on the transfer belt 43 onto a sheet serving as an image forming medium.

The sheet feeding unit 30 feeds the sheet, on which the toner image is transferred, from the transfer belt 43 functioning as the intermediate transfer member to the transfer device 45. The sheet feeding unit 30 has a configuration for feeding the sheet to a position for transfer of the toner image by the transfer device 45 at appropriate timing. In the configuration example shown in FIG. 1, the sheet feeding unit 30 includes plural cassettes 31, pickup rollers 33, separating mechanisms 35, conveying rollers 37, and aligning rollers 39.

The plural cassettes 31 store sheets serving as image forming media, respectively. The cassettes 31 store sheets of arbitrary sizes. Each of the pickup rollers 33 takes out the sheets from the cassette 31 one by one. Each of the separating mechanism 35 prevents the pickup roller 33 from taking out two or more sheets from the cassette at a time (separates the sheets one by one). The conveying rollers 37 convey the one sheet separated by the separating mechanism 35 to the aligning rollers 39. The aligning rollers 39 send, at timing when the transfer device 45 transfers the toner image from the transfer belt 43 (the toner image moves (in the transfer position)), the sheet to a transfer position where the transfer device 45 and the transfer belt 43 are set in contact with each other.

The fixing device 46 fixes the toner image on the sheet. For example, the fixing device 46 fixes the toner image on the sheet by heating the sheet in a pressed state. The fixing device 46 applies fixing processing to the sheet on which the toner image is transferred by the transfer device 45 and conveys the sheet subjected to the fixing processing to the stock unit 48. The stock unit 48 is a paper discharge unit to which a sheet subjected to image forming processing (having an image printed thereon) is discharged. The belt cleaner 47 cleans the transfer belt 43. The belt cleaner 47 removes a waste toner remaining on a transfer surface, onto which the toner image on the transfer belt 43 is transferred, from the transfer belt 43.

A configuration of a control system of the digital multi function peripheral 1 is explained.

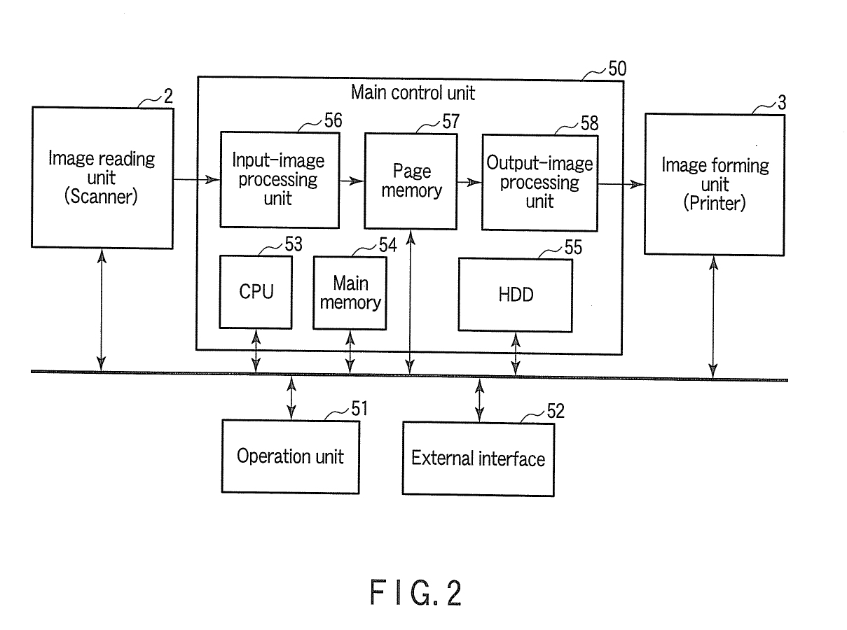

FIG. 2 is a block diagram of a configuration example of the control system in the digital multi function peripheral 1.

As shown in FIG. 2, the digital multi function peripheral 1 includes, as components of the control system, the image reading unit (the scanner) 2, the image forming unit (the printer) 3, a main control unit 50, an operation unit (a control panel) 51, and an external interface 52.

The main control unit 50 controls the entire digital multi function peripheral 1. Specifically, the main control unit 50 receives an operation instruction from the user in the operation unit 51 and controls the image reading unit 2, the image forming unit 3, and the external interface 52.

As explained above, the image reading unit 2 and the image forming unit 3 include the configurations for treating a color image. For example, when color copy processing is performed, the main control unit 50 converts a color image of an original document read by the image reading unit 2 into color image data for print and subjects the color image data to print processing with the image forming unit 3. As the image forming unit 3, a printer of an arbitrary image forming type can be applied. For example, the image forming unit 3 is not limited to the printer of the electrophotographic type explained above and may be a printer of an ink jet type or a printer of a thermal transfer type.

The operation unit 51 receives the input of an operation instruction from the user and displays guidance for the user. The operation unit 51 includes a display device and operation keys. For example, the operation unit 51 includes a liquid crystal display device incorporating a touch panel and hard keys such as a ten key.

The external interface 52 is an interface for performing communication with an external apparatus. The external interface 52 is an external device such as a facsimile communication unit (a facsimile unit) or a network interface.

A configuration in the main control unit 50 is explained.

As shown in FIG. 2, the main control unit 50 includes a CPU 53, a main memory 54, a HDD 55, an input-image processing unit 56, a page memory 57, and an output-image processing unit 58.

The CPU 53 manages the control of the entire digital multi function peripheral 1. The CPU 53 realizes various functions by executing, for example, a program stored in a not-shown program memory. The main memory 54 is a memory in which work data and the like are stored. The CPU 53 realizes various kinds of processing by executing various programs using the main memory 54. For example, the CPU 53 realizes copy control by controlling the scanner 2 and the printer 3 according to a program for copy control.

The HDD (hard disk drive) 55 is a nonvolatile large-capacity memory. For example, the HDD 55 stores image data. The HDD 55 also stores set values (default set values) in the various kinds of processing. For example, a quantization table explained later is stored in the HDD 55. The programs executed by the CPU 53 may be stored in the HDD 55.

The input-image processing unit 56 processes an input image. The input-image processing unit 56 processes input image data input from the scanner 2 and the like according to an operation mode of the digital multi function peripheral 1. The page memory 57 is a memory that stores image data to be processed. For example, the page memory 57 stores color image data for one page. The page memory 57 is controlled by a not-shown page memory control unit. The output-image processing unit 58 processes an output image. In the configuration example shown in FIG. 2, the output-image processing unit 58 generates image data to be printed on a sheet by the printer 3.

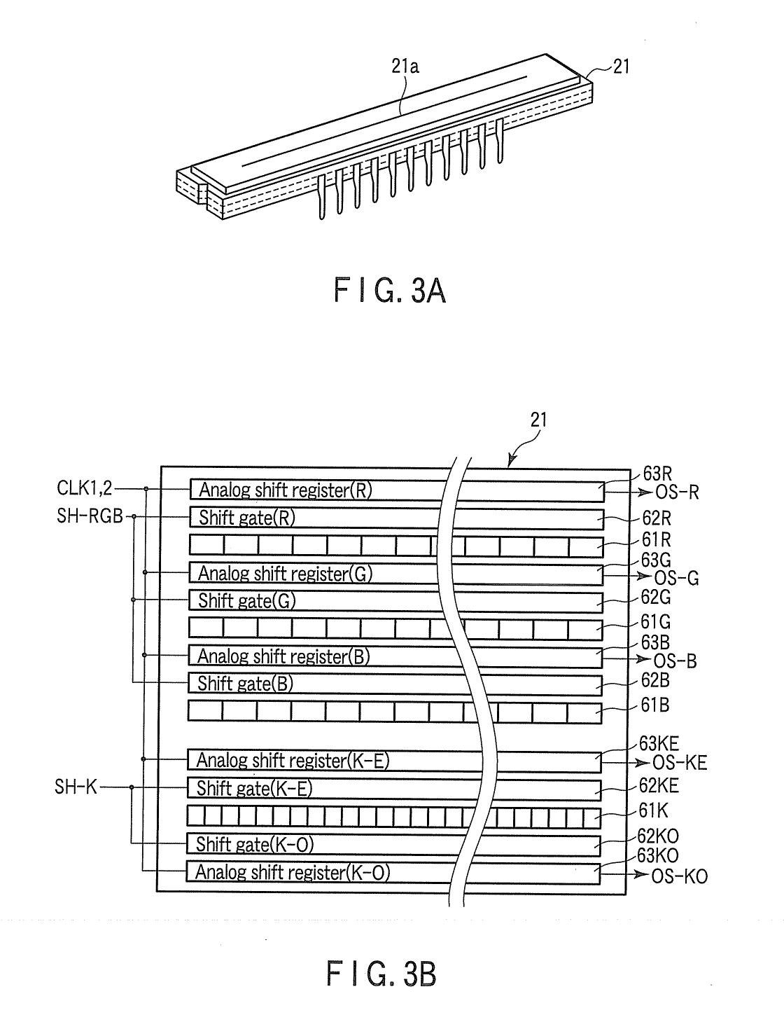

FIG. 3A is an external view of a four-line CCD sensor module serving as the photoelectric conversion unit 21. FIG. 3B is a diagram of a configuration example in the photoelectric conversion unit 21.

The photoelectric conversion unit 21 includes a light receiving unit 21a for receiving light. The photoelectric conversion unit 21 includes the four line sensors, i.e., the red line sensor 61R, the green line sensor 61G, the blue line sensor 61B, and the monochrome line sensor 61K. In each of the line sensors, photoelectric conversion elements (photodiodes) as light receiving elements are arranged in the main scanning direction for plural pixels. The line sensors 61R, 61G, 61B, and 61K are arranged in parallel to the light receiving unit 21a of the photoelectric conversion unit 21. The line sensors 61R, 61G, 61B, and 61K are arranged side by side in parallel such that the line sensors are arranged at specified intervals in the sub-scanning direction.

The red line sensor 61R converts red light into an electric signal. The red line sensor 61R is a line CCD sensor having sensitivity to light in a red wavelength range. The red line sensor 61R is a line CCD sensor in which an optical filter that transmits only the light in the red wavelength range is arranged.

The green line sensor 61G converts green light into an electric signal. The green line sensor 61G is a line CCD sensor having sensitivity to light in a green wavelength range. The green line sensor 61G is a line CCD sensor in which an optical filter that transmits only the light in the green wavelength range is arranged.

The blue line sensor 61B converts blue light into an electric signal. The blue line sensor 61B is a line CCD sensor having sensitivity to light in a blue wavelength range. The blue line sensor 61B is a line CCD sensor in which an optical filter that transmits only the light in the blue wavelength range is arranged.

The monochrome line sensor 61K converts lights of all the colors into electric signals. The monochrome line sensor 61K is a line CCD sensor having sensitivity to lights in a wide wavelength range including wavelength ranges of the colors. The monochrome line sensor 61K is a line CCD sensor in which an optical filter is not arranged or a line CCD sensor in which a transparent filter is arranged.

Pixel pitches and the numbers of pixels of the line sensors are explained.

The red line sensor 61R, the green line sensor 61G, and the blue line sensor 61B as the three line sensors for colors have the same pixel pitch and the same number of light receiving elements (photodiodes), i.e., the same number of pixels. For example, in the red line sensor 61R, the green line sensor 61G, and the blue line sensor 61B, photodiodes are arranged as light receiving elements at a pitch of 9.4 μm. In each of the red line sensor 61R, the green line sensor 61G, and the blue line sensor 61B, light receiving elements for 3750 pixels are arranged in an effective pixel area.

The monochrome line sensor 61K is different from the red line sensor 61R, the green line sensor 61G, and the blue line sensor 61B in a pixel pitch and the number of pixels. For example, in the monochrome line sensor 61K, photodiodes are arranged as light receiving elements at a pitch of 4.7 μm. In the monochrome line sensor 61K, light receiving elements for 7500 pixels are arranged in an effective pixel area. In this example, the pitch (a pixel pitch) of the light receiving elements in the monochrome line sensor 61K is half as large as the pitch (a pixel pitch) of the light receiving elements in the red line sensor 61R, the green line sensor 61G, and the blue line sensor 61B. The number of pixels in the effective pixel area of the monochrome line sensor 61K is twice as large as the number of pixels in the effective pixels areas of the color line sensors 61R, 61G, and 61B.

Such four line sensors 61R, 61G, 61B, and 61K are arranged side by side in parallel such that the line sensors are arranged at specified intervals in the sub-scanning direction. In the line sensors 61R, 61G, 61B, and 61K, pixel data to be read shifts in the sub-scanning direction by the specified intervals. When a color image is read, in order to correct the shift in the sub-scanning direction, image data read by the line sensors 61R, 61G, 61B, and 61K are stored by a line memory or the like.

Characteristics of the line sensors 61R, 61G, 61B, and 61K are explained.

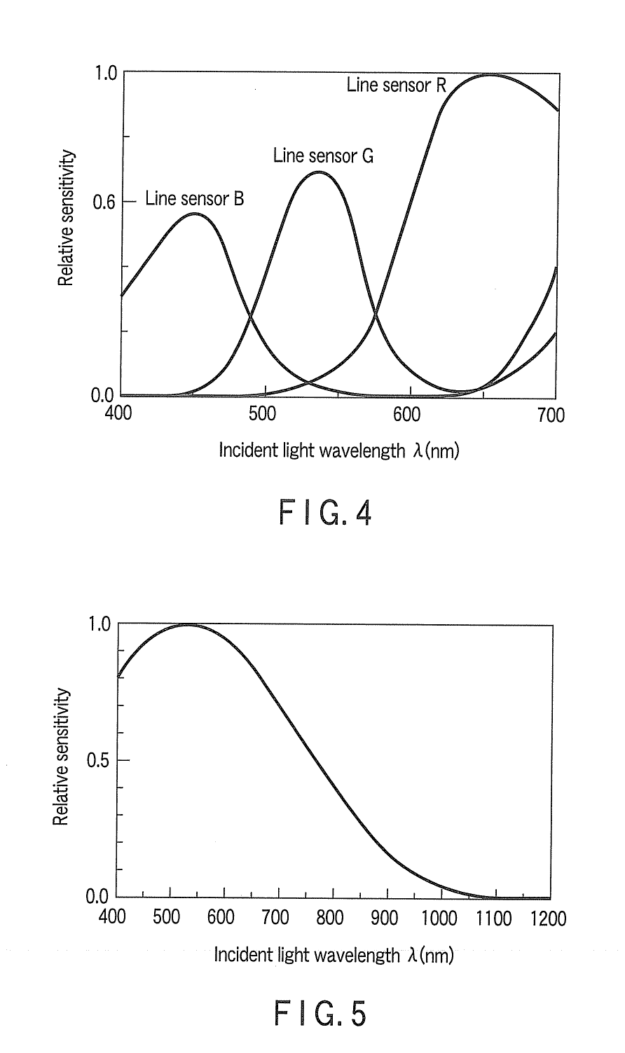

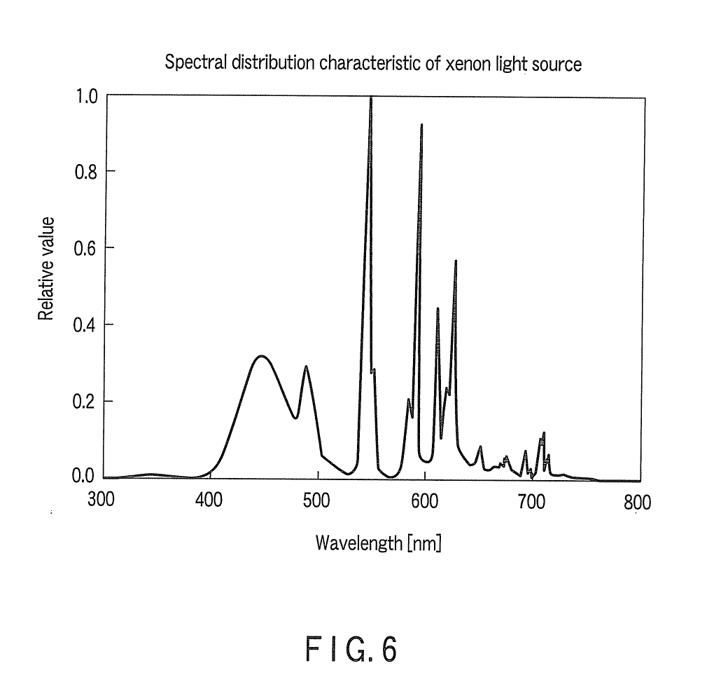

FIG. 4 is a graph of spectral sensitivity characteristics of the three color line sensors 61R, 61G, and 61B. FIG. 5 is a graph of a spectral sensitivity characteristic of the monochrome line sensor 61K. FIG. 6 is a graph of a spectral distribution of a xenon lamp used as the light source 11.

As shown in FIG. 4, the red line sensor 61R, the green line sensor 61G, and the blue line sensor 61B have sensitivity only to wavelengths in specific ranges. On the other hand, as shown in FIG. 5, the monochrome line sensor 61K has sensitivity to a wavelength range from a wavelength smaller than 400 nm to a wavelength exceeding 1000 nm (has sensitivity to wavelengths in a wide range). On the other hand, as shown in FIG. 6, the xenon lamp as the light source 11 for illuminating a reading surface of an original document emits light including lights having wavelengths from about 400 nm to 730 nm.

It is assumed that light from the light source 11 shown in FIG. 6 is reflected on a white original document and irradiated on the four-line CCD sensor 21. The monochrome line sensor 61K has sensitivity per unit area higher than those of the color sensors 61R, 61G, and 61B. The monochrome line sensor 61K obtains equivalent sensitivity even if a light receiving area thereof is small compared with the color line sensors 61R, 61G, and 61B. Therefore, the light receiving area of the monochrome line sensor 61K is smaller than those of the color line sensors 61R, 61G, and 61B. The number of pixels of the monochrome line sensor 61K is larger than that of the color line sensors 61R, 61G, and 61B.

In the examples shown in FIGS. 4 and 5, the monochrome line sensor 61K has sensitivity per unit area twice as large as that of the color line sensors 61R, 61G, and 61B. Therefore, the monochrome line sensor 61K has a light receiving area half as large as that of the color line sensors 61R, 61G, and 61B and the number of pixels twice as large as that of the color line sensors 61R, 61G, and 61B. Since the number of pixels is twice as large as that of the color line sensors 61R, 61G, and 61B, the monochrome sensor 61K has resolution twice as high as that of the color line sensors 61R, 61G, and 61B in the main scanning direction.

An internal configuration of the photoelectric conversion unit 21 is explained.

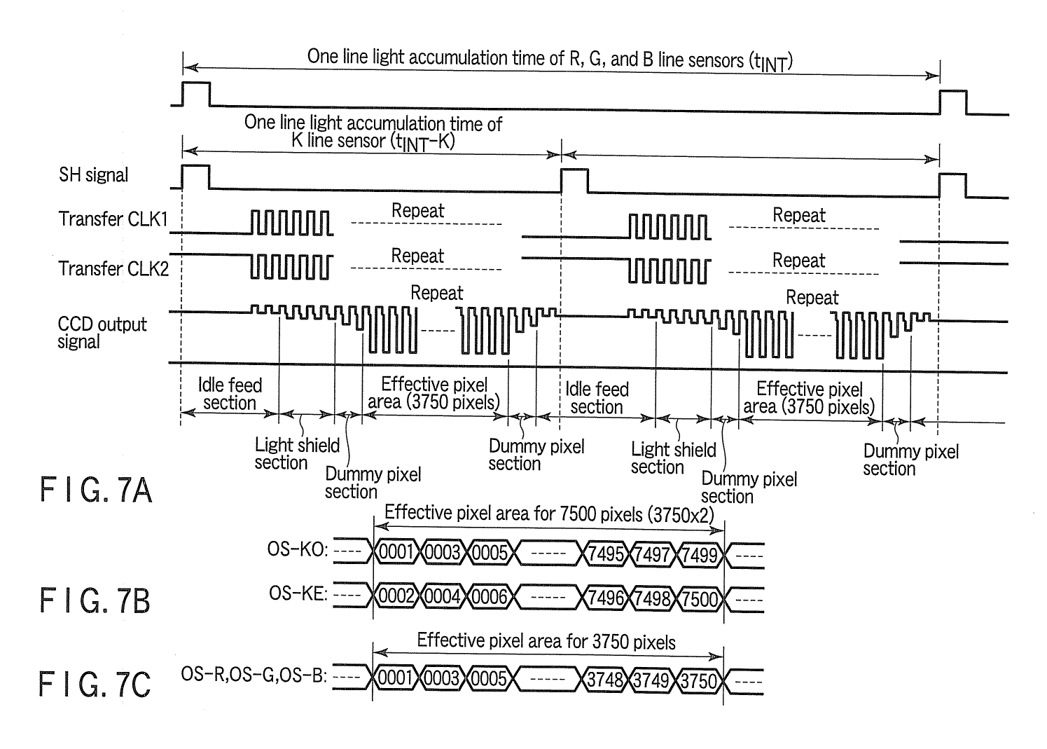

FIG. 7A is a timing chart of the operation of the line sensors 61R, 61G, 61B, and 61K shown in FIG. 3B and various signals. FIG. 7B is a diagram of a pixel signal output by the monochrome line sensor 61K. FIG. 7C is a diagram of a pixel signal output by the color line sensors 61R, 61G, and 61B.

First, a flow of a signal from the line sensors 61R, 61G, 61B, and 61K in the configuration example shown in FIG. 3B is explained.

As shown in FIG. 3B, the line sensors 61R, 61G, and 61B correspond to shift gates 62R, 62G, and 62B and shift registers 63R, 63G, and 63B, respectively. The monochrome sensor 61K corresponds to two shift gates 62KO and 62KE and two analog shift registers 63KO and 63KE. When light is irradiated on the line sensors 61R, 61G, 61B, and 61K, the light receiving elements (the photodiodes) for the number of pixels configuring the line sensors 61R, 61G, 61B, and 61K generate, for each of the pixels, charges corresponding to an irradiated light amount and irradiation time.

For example, the light receiving elements (the photodiodes) in the line sensors 61R, 61G, and 61B supply the generated charges corresponding to the pixels to the analog shift registers 63R, 63G, and 63B via the shift gates 62R, 62G, and 62B as a shift signal (SH-RGB). The analog shift registers 63R, 63G, and 63B serially output, in synchronization with transfer clocks CLK1 and CLK2, pieces of pixel information (OS-R, OS-G, and OS-B) as charges corresponding to the pixels supplied from the line sensors 61R, 61G, and 61B. The pieces of pixel information (OS-R, OS-G, and OS-B) output by the analog shift registers 63R, 63G, and 63B in synchronization with the transfer clocks CLK1 and CLK2 are signals indicating values of red (R), green (G), and blue (B) in the pixels, respectively.

The number of light receiving elements (e.g., 7500) of the monochrome line sensor 61K is twice as large as the number of light receiving elements (e.g., 3750) of the line sensors 61R, 61G, and 61B. One monochrome line sensor 61K is connected to the two shift gates 62KO and 62KE and the two analog shift registers 63KO and 63KE. The shift gate 62KO is connected to correspond to odd-number-th pixels (light receiving elements) in the line sensor 61K. The shift gate 62KE is connected to correspond to even-number-th pixels (light receiving elements) in the line sensor 61K.

The odd-number-th light receiving elements and the even-number-th light receiving elements in the line sensor 61K supply the generated charges corresponding to the pixels to the analog shift registers 63KO and 63KE via the shift gates 62KO and 62KE as a shift signal (SH-K). The analog shift registers 63KO and 63KE serially output, in synchronization with the transfer clocks CLK1 and CLK2, pixel information (OS-KO) as the charges corresponding to the odd-number-th pixels in the line sensor 61K and pixel information (OS-KE) as the charges corresponding to the even-number-th pixels. The pieces of pixel information (OS-KO and OS-KE) output by the analog shift registers 63KO and 63KE in synchronization with the transfer clocks CLK1 and CLK2 are respectively signals indicating a value of luminance in the odd-number-th pixels and a value of luminance in the even-number-th pixels.

The transfer clocks CLK1 and CLK2 are represented by one line in the configuration example shown in FIG. 3B. However, in order to move charges at high speed, the transfer clocks CLK1 and CLK2 are differential signals having opposite phases.

Output timing of a signal from the line sensors 61R, 61G, and 61B and output timing of a signal from the line sensor 61K are explained.

As shown in FIG. 7A, output timing of a signal from the line sensors 61R, 61G, and 61B and output timing of a signal from the line sensor 61K are different. Light accumulation time “tINT-RGB” corresponding to a period of an SH-RGB signal and light accumulation time “tINT-K” corresponding to a period of an SH-K signal are different. This is because the sensitivity of the line sensor 61K is higher than the sensitivity of the line sensors 61R, 61G, and 61B.

In the example shown in FIG. 7A, the light accumulation time “tINT-K” of the line sensor 61K is half as long as the light accumulation time “tINT-RGB” of the line sensors 61R, 61G, and 61B. The reading resolution in the sub-scanning direction of the line sensor 61K is twice as high as that of the line sensors 61R, 61G, and 61B. For example, when the reading resolution of the line sensor 61K is 600 dpi, the reading resolution of the line sensors 61R, 61G, and 61B is 300 dpi.

The transfer clocks CKL1 and CLK2 are common to the line sensors 61R, 61G, and 61B and the line sensor 61K. Therefore, OS-R, OS-G, and OS-B output in synchronization with the transfer clocks CKL1 and CLK2 after both the SH-K signal and the SH-RGB signals are output are valid signals. However, OS-R, OS-G, and OS-B output in synchronization with the transfer clocks CLK1 and CLK2 after the SH-RGB signal is not output and only the SH-K signal is output are invalid signals.

FIG. 7B is a diagram of output order of pixels of OS-R, OS-G, and OS-B serially output at the timing shown in FIG. 7A. FIG. 7C is a diagram of output order of pixels of OS-KE and OS-KO serially output at the timing shown in FIG. 7A. As shown in FIG. 7C, the monochrome line sensor 61K simultaneously outputs an odd-number-th pixel value and an even-number-th pixel value as the luminance signal (OS-K).

Processing of signals output from the four-line CCD sensor functioning as the photoelectric conversion unit 21 is explained.

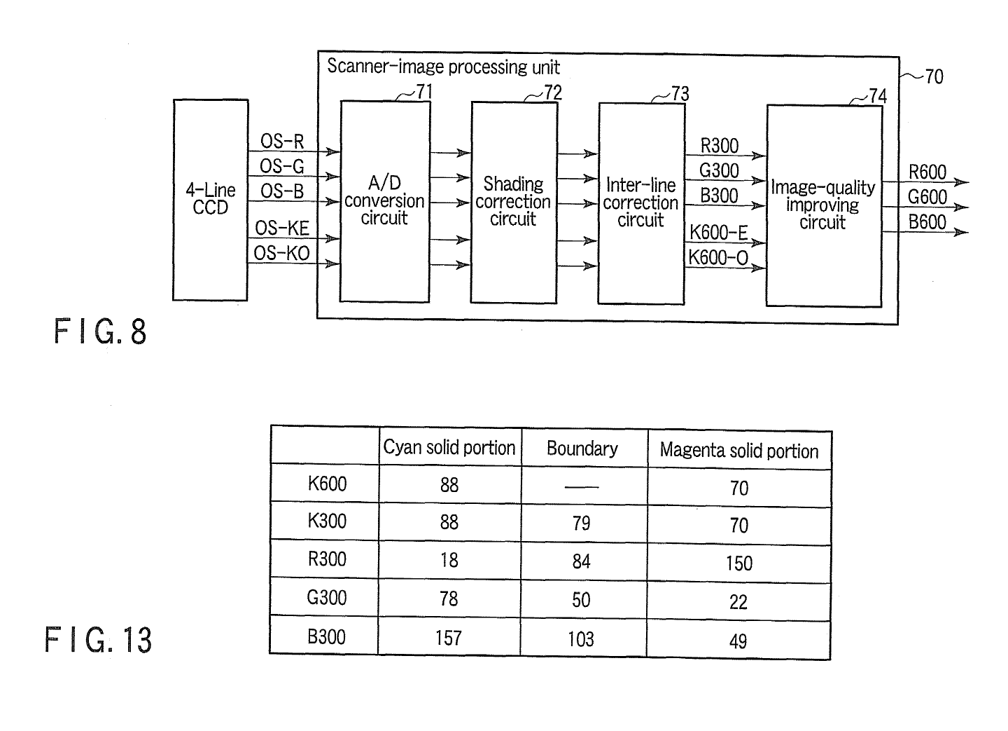

FIG. 8 is a diagram of a configuration example of a scanner-image processing unit 70 that processes a signal from the photoelectric conversion unit 21.

In the configuration example shown in FIG. 8, the scanner-image processing unit 70 includes an A/D conversion circuit 71, a shading correction circuit 72, an inter-line correction circuit 73, and an image-quality improving circuit 74.

As shown in FIG. 3B, the photoelectric conversion unit 21 outputs signals in five system, i.e., the three color signals OS-R, OS-G, and OS-B as output signals from the line sensors 61R, 61G, and 61B and the luminance signals OS-KO and OS-KE as output signals from the line sensor 61K.

The A/D conversion circuit 71 in the scanner-image processing unit 70 is input with the signals in the five systems. The A/D conversion circuit 71 converts the input signals in the five systems into digital data, respectively. The A/D conversion circuit 71 outputs the converted digital data to the shading correction circuit 72. The shading correction circuit 72 corrects signals from the A/D conversion circuit 71 according to a correction value corresponding to a reading result of a not-shown shading correction plate (a white reference plate). The shading correction circuit 72 outputs the signals subjected to shading correction to the inter-line correction circuit 73.

The inter-line correction circuit 73 corrects phase shift in the sub-scanning direction in the signals. An image read by a four-line CCD sensor shifts in the sub-scanning direction. Therefore, the inter-line correction circuit 73 corrects the shift in the sub-scanning direction. For example, the inter-line correction circuit 73 accumulates image data (digital data) read earlier in a line buffer and outputs the image data to be timed to coincide with image data read later. The inter-line correction circuit 73 outputs signals subjected to inter-line correction to the image-quality improving circuit 74.

The image-quality improving circuit 74 outputs three color signals set to high resolution on the basis of the five signals from the inter-line correction circuit 73. As explained above, in image data read by the photoelectric conversion unit 21, a monochrome (luminance) image signal has resolution higher than that of color image signals. It is assumed that color image data has resolution of 300 dpi (R300, G300, and B300) and monochrome (luminance) image data has resolution of 600 dpi (K600-O and K600-E) twice as high as that of the color image data. In this case, the image-quality improving circuit 74 generates 600 dpi color image data (R600, G600, and B600) on the basis of the 300 dpi color image data and the 600 dpi monochrome image data. The image-quality improving circuit 74 reduces noise and correct blur.

Signal processing (resolution increasing processing) in the image-quality improving circuit 74 is explained in detail.

In the following explanation, digital data corresponding to the signal OS-R indicating a red pixel value is referred to as R300, digital data corresponding to the signal OS-G indicating a green pixel value is referred to as G300, and digital data corresponding to the signal OS-B indicating a blue pixel value is referred to as B300, digital data corresponding to the signal OS-KO indicating the luminance of odd-number-th pixels is referred to as K600-O, and digital data corresponding to the signal OS-KE indicating the luminance of even-number-th pixels is referred to as K600-E.

First, a procedure for increasing the resolution of color image signals read by the line sensors 61R, 61G, and 61B to resolution equivalent to that of the line sensor 61K is explained.

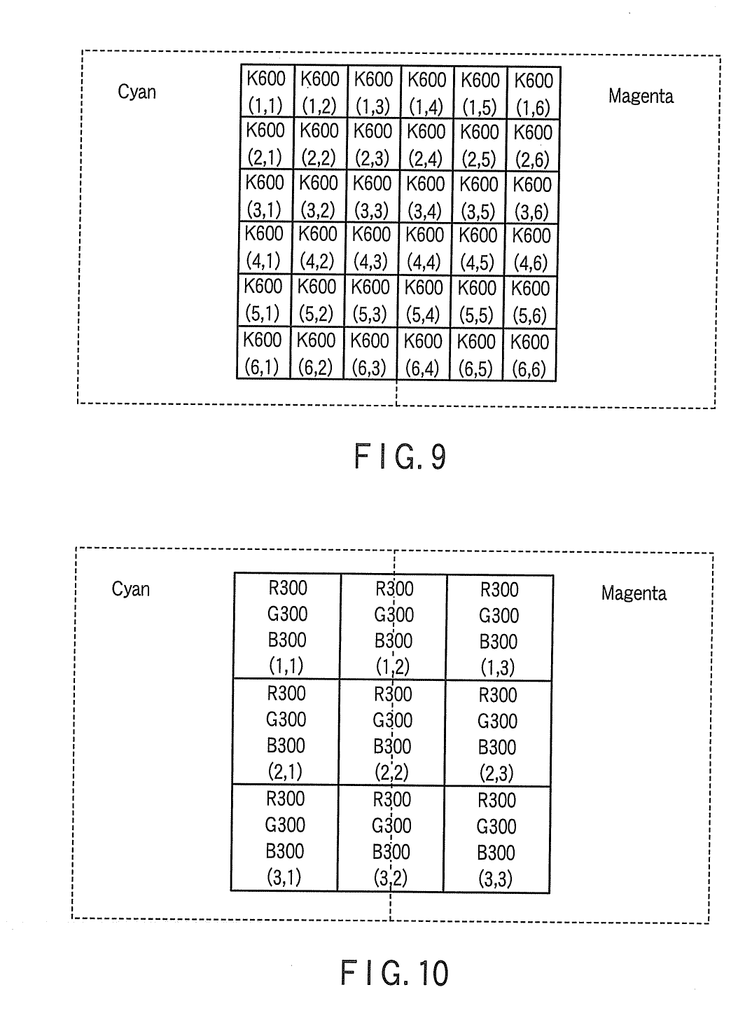

FIG. 9 is a diagram of pixels read by the line sensor 61K. FIG. 10 is a diagram of pixels in the same range as FIG. 9 read by the line sensors 61R, 61G, and 61B. In FIGS. 9 and 10, pixels read by the line sensor 61K and pixels read by the line sensors 61R, 61G, and 61B are shown, respectively.

In the following explanation, the left to right direction on the paper surface is the main scanning direction as an arrangement direction of light receiving elements (pixels) in a line sensor and the up to down direction on the paper surface is the sub-scanning direction (a moving direction of a carriage or a moving direction of an original document). The luminance image data (K600-O and K600-E) as pixel data from the line sensor 61K are image data rearranged in order of odd numbers and even numbers. Specifically, in the example shown in FIG. 9, (1,1), (1,3), (1,5), (2,1), (2,3), . . . , and (6,5) of K600 are the output of the odd-number-th pixel signal (K600-O). In the example shown in FIG. 9, (1,2), (1,4), (1,6), (2,2), (2,4), . . . , and (6,6) of K600 are equivalent to the output of the even-number-th pixel signal (K600-E).

The resolution of the monochrome line sensor 61K is twice as large as that of the color line sensors 61R, 61G, and 61B. This means that one pixel read by the color line sensors 61R, 61G, and 61B corresponds to four (=2×2) pixels read by the monochrome line sensor 61K. For example, a range of four pixels including K600(1,1), K600(1,2), K600(2,1), and K600(2,2) shown in FIG. 9 is equivalent to one pixel of RGB300(1,1) shown in FIG. 10. In other words, a reading range of 6 pixels×6 pixels (36 pixels) read by the line sensor 61K corresponds to a reading range of 3 pixels×3 pixels (9 pixels) read by the line sensors 61R, 61G, and 61B. An area of the reading range of 6 pixels×6 pixels read by the line sensor 61K is an area equal to the reading range of 3 pixels×3 pixels read by the line sensors 61R, 61G, and 61B.

As an example, it is assumed that an image in which a cyan solid image and a magenta solid image are in contact with each other is read. It is assumed that a boundary between the cyan solid image and the magenta solid image is present in the center of a reading range as indicated by dotted lines in FIGS. 9 and 10. The left side of the dotted line as the boundary on the paper surface in FIGS. 9 and 10 is the cyan solid image and the right side is the magenta solid image.

Pixels {K600(1,1), K600(1,2), K600(1,3), K600(2,1), K600(2,2), K600(2,3), . . . , and K600(6,3)} located on the left side of the dotted line shown in FIG. 9 are pixels in which the line sensor 61K reads the cyan solid image. Pixels {K600(1,4), K600(1,5), K600(1,6), K600(2,4), K600(2,5), K600(2,6), . . . , and K600(6,6)} located on the right side of the dotted line shown in FIG. 9 are pixels in which the line sensor 61K reads the magenta solid image.

On the other hand, pixels {RGB300(1,1), RGB300(2,1), and RGB(3,1)} located on the left side of the dotted line shown in FIG. 10 are pixels in which the line sensors 61R, 61G, and 61B read the cyan solid image. Pixels {RGB300(1,3), RGB300(2,3), and RGB300(3,3)} located on the right side of the dotted line shown in FIG. 10 are pixels in which the line sensors 61R, 61G, and 61B read the magenta solid image. Pixels {RGB300(1,2), RGB300(2,2), and RGB300(3,2)} located on the dotted line shown in FIG. 10 are pixels in which the line sensors 61R, 61G, and 61B read the boundary between the cyan solid image and the magenta solid image. RGB300 is an abbreviation of R300, G300, and B300 shown in FIG. 10.

As explained above, the line sensor 61K reads the cyan solid image in the eighteen pixels located on the left side in FIG. 9 and reads the magenta solid image in the eighteen pixels located on the right side. On the other hand, as shown in FIG. 10, the line sensors 61R, 61G, and 61B read the cyan solid image in the three pixels located on the left side, read the magenta solid image in the three pixels located on the right side, and read both the cyan solid image and the magenta solid image in the three pixels located in the center.

As explained above, the A/D conversion circuit 71 converts pixel signals output from the light receiving elements of the line sensors into digital data (e.g., a 256-gradation data value indicated by 8 bits). As a pixel signal output by the light receiving elements is larger, digital data of the pixels has a larger value (e.g., a value closer to 255 in the case of 255 gradations). The shading correction circuit 72 sets a value of a pixel whiter than a white reference (a brightest pixel) to a large value (e.g., 255) and sets a value of a pixel blacker than a black reference (a darkest pixel) to a small value (e.g., 0).

In the following explanation, it is explained what kinds of values the respective line sensors output when the A/D conversion circuit 71 and the shading correction circuit 72 convert signals of pixels into 8-bit digital data.

When the cyan solid image is read, for example, the line sensor 61R, the line sensor 61G, and the line sensor 61B output data values “18”, “78”, and “157”, respectively. This means that, in reflected light from the cyan solid image, red components are small and blue components are large.

When the magenta solid image is read, for example, the line sensor 61R, the line sensor 61G, and the line sensor 61B output data values “150”, “22”, and “49”, respectively. This means that, in reflected light from the magenta solid image, red components are large and green components are small.

Pixels including both the cyan solid image and the magenta solid image have an output value corresponding to a ratio of the cyan solid image and the magenta solid image. In the example shown in FIG. 10, in the three pixels {RGB300(1,2), RGB300(2,2), and RGB300(3,2)} located on the dotted line (in the center), an area ratio of the cyan solid image and the magenta solid image is 50%. Therefore, an output value of the three pixels {RGB300(1,2), RGB300(2,2), and RGB300(3,2)} on the dotted line is an average of an output value obtained when the cyan solid image is read and an output value obtained when the magenta solid image is read.

Specifically, an output value {R300(1,2), R300(2,2), and R300(3,2)} of the line sensor 61R is 84 (=(18+150)/2). An output value {G300(1,2), G300(2,2), and G300(3,2)} of the line sensor 61G is 50 (=(78+22)/2). An output value {B300(1,2), B300(2,2), and B300(3,2)} of the line sensor 61B is 103 (=(157+49)/2).

Among the pixels read by the line sensor 61K, as shown in FIG. 9, eighteen pixels on the left side of the dotted line are an area of the cyan solid image and eighteen pixels on the right side of the dotted line are an area of the magenta solid image. When an output value of the line sensor 61K for the pixels forming the cyan solid image is “88”, an output value of the pixels on the left side of the dotted line is “88”. When an output value of the line sensor 61K for the pixels forming the magenta solid image is “70”, an output value of the pixels on the right side of the dotted line is “70”.

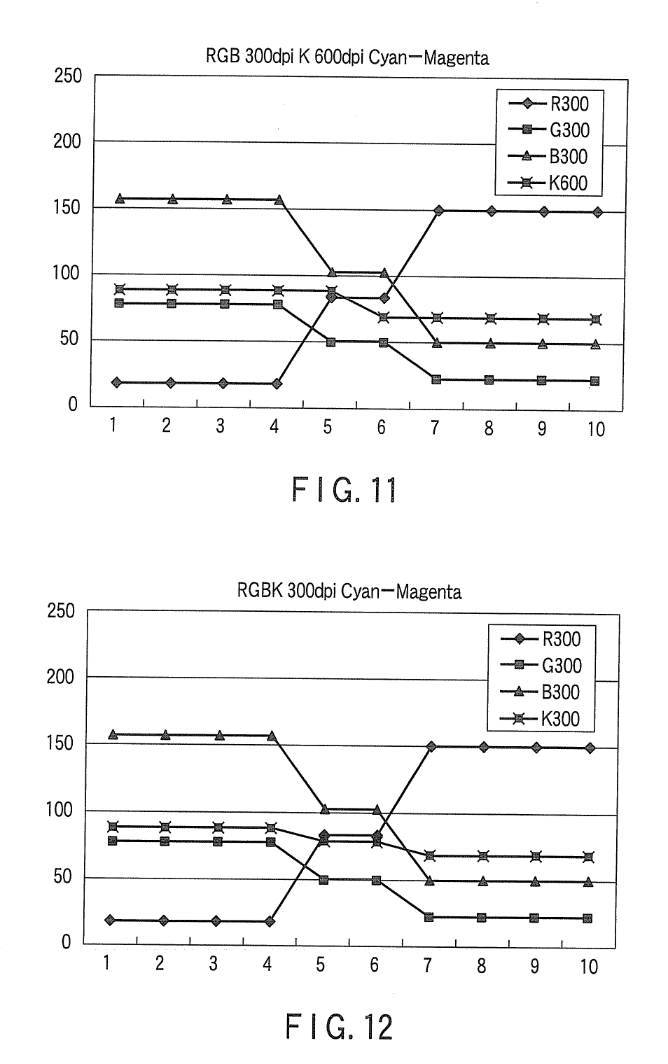

FIG. 11 is a diagram of output values of the sensors explained above shown as a graph (a profile).

In FIG. 11, a state of a signal change in the main scanning direction of a range larger than the reading range shown in FIGS. 9 and 10 is shown. Specifically, in FIG. 11, the line sensors 61R, 61G, and 61B represent an output value for five pixels and the line sensor 61K represents an output value for ten pixels. For example, as a correspondence relation between a first horizontal line shown in FIGS. 9 and 10 and the graph shown in FIG. 11, “3”, “4”, and “5” on the abscissa of the graph shown in FIG. 11 correspond to K600(1,1), K600(1,2), and K600(1,3) and “6”, “7”, and “8” on the abscissa correspond to K600(1,4), K600(1,5), K600(1,6).

The line sensors 61R, 61G, and 61B have a detection range for two pixels of the line sensor 61K in the main scanning direction. Therefore, “3” and “4” on the abscissa of the graph shown in FIG. 11 correspond to RGB300(1,1), “5” and “6” on the abscissa correspond to RGB300(1,2), and “7” and “8” on the abscissa correspond to RGB300(1,3). “1”, “2” and “9”, and “10” on the abscissa of the graph shown in FIG. 11 are on the outside of the area shown in FIGS. 9 and 10.

In the graph shown in FIG. 11, in the main scanning direction, a value of one pixel read by the line sensors 61R, 61G, and 61B corresponds to two pixels of the line sensor 61K. Values for ten pixels of the line sensor 61K corresponds to numerical values “1” to “10” on the abscissa of the graph shown in FIG. 11. Values for five pixels of the line sensors 61R, 61G, and 61B correspond to the numerical values “1” to “10” on the abscissa of the graph shown in FIG. 11. This is because one pixel of the line sensors 61R, 61G, and 61B corresponds to each of “1” and “2”, “3” and “4”, “5” and “6”, “7” and “8”, and “9” and “10” on the abscissa of the graph shown in FIG. 11.

Therefore, “5” and “6” on the abscissa of the graph shown in FIG. 11 are values of obtained by reading pixels, which include 50% of cyan pixels and 50% of magenta pixels, with the line sensors 61R, 61G, and 61B (output values of pixels on the dotted line shown in FIG. 10). As it is evident from the graph shown in FIG. 11, cyan signal components and magenta signal components are mixed in the output values of the pixels corresponding to “5” and “6”. Therefore, the output values of the pixels corresponding to “5” and “6” are averages of values obtained by reading the cyan solid image and values obtained by reading the magenta solid image. As a result, a portion corresponding to “5” and “6” on the abscissa of the graph shown in FIG. 11 is a profile with an unclear boundary.

If a signal of the boundary explained above is a signal as clear as the line sensor 61K signal, this image is high in quality. In order to realize such processing, the image-quality improving circuit 74 processes image data using a correlation between an output value (luminance data: monochrome image data) of the line sensor 61K and output values (color data: color image data) of the line sensors 61R, 61G, and 61B.

A relation between luminance data and color data is explained.

In general, luminance data (K data) can be calculated from color data (e.g., data of R, G, and B). On the other hand, the color data cannot be calculated from the luminance data. In other words, even if brightness (luminance data) of pixels in an image is set, color data (R data, G data, and B data) of the pixels cannot be determined. However, when a range of pixels is limited to a “certain range”, there is a specific relation between the color data and the luminance data. In such a range in which the specific relation holds, the color data can be calculated from the luminance data. The specific relation in the “certain range” is a correlation between the luminance data and the color data. If the correlation is referred to, it is possible to convert, using luminance data having high resolution (second resolution), color data having low resolution (first resolution) into color data having resolution equivalent to that of the luminance data. The image-quality improving circuit 74 improves the resolution of color image data on the basis of the correlation explained above.

A procedure of image-quality improving processing is explained below.

In the following explanation, image data used in the image-quality improving processing is color data in the 3×3 pixel matrix shown in FIG. 10 (color image data including color pixel data for nine pixels) and luminance data in the 6×6 pixel matrix shown in FIG. 9 (monochrome image data including monochrome pixel data for thirty-six pixels) corresponding to the 3×3 pixel matrix of the color data. In other words, a 3×3 pixel matrix in 300 dpi color data corresponds to a 6×6 pixel matrix in 600 dpi luminance data.

First, the image-quality improving circuit 74 calculates a correlation between color data (R data, G data, and B data) and luminance data (K data). In order to calculate the correlation, the image-quality improving circuit 74 converts the resolution of the luminance data into resolution same as that of the color data. When the luminance data has resolution of 600 dpi and the color data has resolution of 300 dpi, the image-quality improving circuit 74 converts the resolution of the luminance data into 300 dpi. The image-quality improving circuit 74 converts luminance data having high resolution into luminance data having resolution same as that of the color data by the following procedure, for example.

The image-quality improving circuit 74 associates pixels read by the line sensor 61K with pixels read by the line sensors 61R, 61G, and 61B. For example, the image-quality improving circuit 74 associates the pixels read by the line sensor 61K shown in FIG. 9 with the pixels read by the line sensors 61R, 61G, and 61B shown in FIG. 10. In this case, the 2×2 pixel matrix in the luminance data corresponds to the respective pixels in the color data (a color reading area). Therefore, the image-quality improving circuit 74 calculates an average of the luminance data in the 2×2 pixel matrix corresponding to the respective pixels of the color data (the color reading area). As a result of this processing, the luminance data for thirty-six pixels (the 600 dpi luminance data) changes to luminance data for nine pixels equivalent to 300 dpi. The luminance data equivalent to 300 dpi is represented as K300.

In the example explained above, the value of the luminance data of the cyan solid image is “88” and the value of the luminance data of the magenta solid image is “70”. The value (the average) of the luminance data of the 2×2 pixel matrix including the two pixels of the cyan solid image and the two pixels of the magenta solid image is “79 (=88+70+88+70)/4”. Therefore, luminance data equivalent to 300 dpi including the four pixels including the boundary of cyan and magenta has a value “79”.

FIG. 12 is a diagram of a profile of the luminance data (K300) equivalent to 300 dpi explained above shown as a graph.

As shown in FIG. 12, like R300, G300, and B300, the luminance data K300 equivalent to 300 dpi is a value of “79” as an average of the cyan solid image and the magenta solid image in “5” and “6” (i.e., the pixels corresponding to the boundary) on the abscissa of the graph.

FIG. 13 is a table of values corresponding to an area of the cyan solid image (a cyan image portion), an area of the magenta solid image (a magenta image portion), and an area of pixels including the boundary in which the cyan solid image and the magenta solid image are mixed (a boundary portion).

A correlation between the luminance data (the K data) and the color data (the R data, the G data, and the B data) is explained.

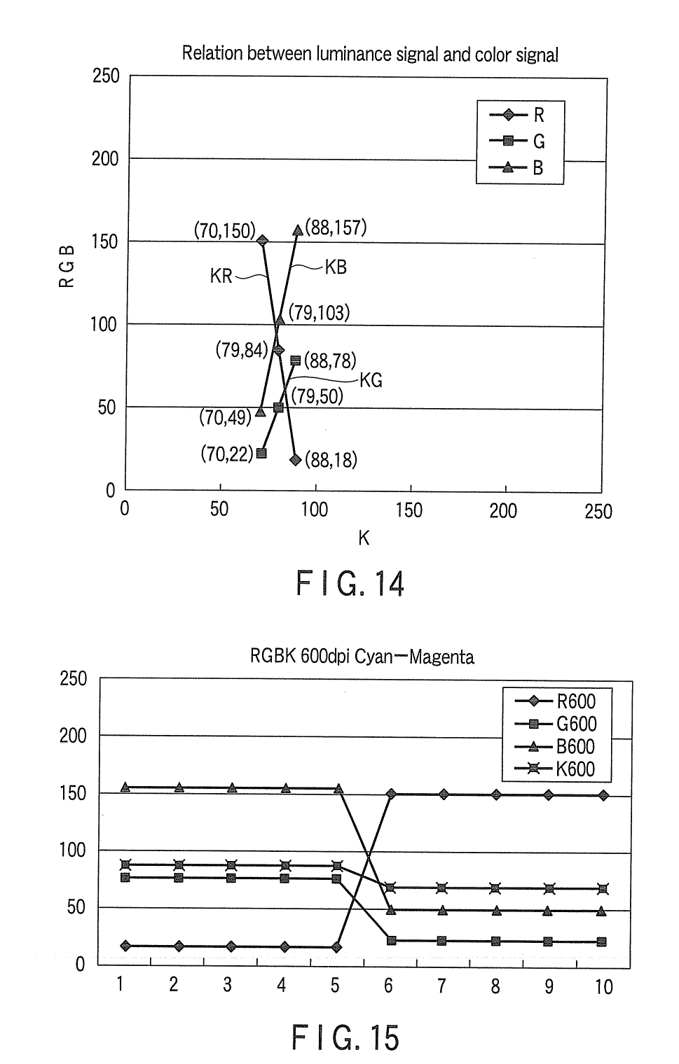

FIG. 14 is a scatter diagram with values of luminance data plotted on the abscissa and values of color data plotted on the ordinate. The correlation between the luminance data and the color data is explained with reference to FIG. 14.

First, a correlation between the luminance data (the K data) and the red data (the R data) is explained.

As shown in FIG. 14, when the luminance data and the red data are represented as (K data, R data), three points (70, 150), (79, 84), and (88, 18) are arranged on a straight line KR. The straight line KR indicates the correlation between the luminance data and the red data. The straight line KR is a straight line slanting down to the right. The straight line KR indicates that, in nine pixels in the 3×3 pixel matrix, when the luminance data increases, the red data decreases and, when the luminance data decreases, the red data increases. In other words, the straight line KR indicates that the luminance data and the red data have a negative correlation. The straight line KR passes (70, 150) and (88, 18). Therefore, as the correlation between the luminance data and the red data, the following Formula (K-R) holds:

R−150=(150−18)/(70−88)*(K−70) (K-R)

R≡−7.33*K+663.3

The straight line KR shown in FIG. 14 indicates a correlation between the 300 dpi K data and the 300 dpi R data. Such a correlation is considered to also hold at resolution of 600 dpi in the 3×3 pixel matrix, i.e., the “certain range”. According to this idea, when the 600 dpi luminance data (K600) is substituted in “K” of Formula (K-R), R data of pixels equivalent to 600 dpi is calculated. For example, concerning 300 dpi pixels (pixels in which the R data is “84”) in the boundary area in which the cyan solid image and the magenta solid image are mixed, R data equivalent to 600 dpi is “150” in a pixel portion in which the 600 dpi K data (K600) is “70” and R data equivalent to 600 dpi is “18” in a pixel portion in which the 600 dpi K data (K600) is “88”.

A correlation between the K data (the luminance data) and the G data (the green data) is explained.

As in the case of the R data, the luminance data of the cyan solid image is “88” and the G data thereof is “78”, the luminance data of the magenta solid image is “70” and the G data thereof is “22”, and the luminance data obtained by reading the boundary of cyan and magenta is “79” and the G data thereof is “50”. Therefore, when the luminance data and the green data are represented as (K data, G data), three points (70, 22), (79, 50), and (88, 78) are arranged on a straight line KG. As shown in FIG. 14, the straight line KG indicating the correlation between the luminance data and the green data is a straight line slanting up to the right. The straight line KG indicates that, in the range of the 3×3 pixel matrix, when the luminance data increases, the green data also increases and, when the luminance data decreases, the green data also decreases. In other words, the straight line KG indicates that the luminance data and the green data have a positive correlation. The straight line KG passes (70, 22) and (88, 78). Therefore, as a formula indicating the correlation between the luminance data and the green data, the following Formula (K-G) holds:

G−22=(22−78)/(70−88)*(K−70) (K-G)

G≡3.11*K−195.8

As in the case of the R data, when the 600 dpi luminance data is substituted in “K” of Formula (K-G), 600 dpi G data is calculated. Therefore, concerning pixels in which 300 dpi G data is “50”, if the 600 dpi luminance data (K600) is “70”, G data equivalent to 600 dpi is “22” and, if the 600 dpi luminance data (K600) is “88”, the G data equivalent to 600 dpi is “78”.

A correlation between the K data (the luminance data) and the B data (the blue data) is explained.

As in the case of the R data or the G data, the luminance data of the cyan solid image is “88” and the B data thereof is “157”, the luminance data of the magenta solid image is “70” and the B data thereof is “49”, and the luminance data of the boundary where the cyan solid image and the magenta solid image are mixed is “79” and the B data thereof is “103”. When the luminance data and the blue data are represented as (K data, B data), as shown in FIG. 14, three points (70, 49), (79, 103), and (88, 157) are arranged on a straight line KB. The straight line KB indicating the correlation between the luminance data and the blue data is a straight line slanting up to the right. The straight line KB indicates that, in the range of the 3×3 pixel matrix, when the luminance data increases, the blue data also increases and, when the luminance data decreases, the blue data also decreases. The straight line KB indicates that the luminance data and the blue data have a positive correlation. The straight line KB passes (70, 49) and (88, 157). Therefore, as a formula indicating the correlation between the luminance data and the blue data, the following Formula (K-B) holds:

B−49=(49−157)/(70−88)*(K−70) (K-B)

B=6*K−371

As in the case of the R data or the G data, when the 600 dpi luminance data (K600) is substituted in “K” of Formula (K-B), 600 dpi B data is calculated. Therefore, concerning pixels in which the 300 dpi B data is “103”, if the 600 dpi luminance data is “70”, B data equivalent to 600 dpi is “49” and, if the 600 dpi luminance data is “88” G data equivalent to 600 dpi is “157”.

FIG. 15 is a graph of color data equivalent to 600 dpi generated on the basis of the correlation shown in FIG. 14.

According to the calculation example based on the correlation explained above, as shown in FIG. 15, in “5” on the abscissa of the graph (equivalent to the left side among the pixels in the boundary), the R data is “18”, the G data is “78”, and the B data is “157”. In “6” on the abscissa of the graph (equivalent to the right side among the pixels in the boundary), the R data is “150”, the G data is “22”, and the B data is “49”. A pixel portion of 300 dpi including the boundary in this way is separated into a signal of “5” and a signal of “6” equivalent to 600 dpi.

Specifically, in the processing result shown in FIG. 15, the R, G, and B data in the boundary are separated into a pixel value equivalent to the cyan solid image and a pixel value equivalent to the magenta solid image. According to such a processing result, the boundary in the image is clarified. This means that the resolution of the color signal is increased.

Image-quality improving processing for general image data is explained.

In the image-quality improving processing explained above, the resolution of the color data is increased to be higher than that of the original color data by using the luminance data (the monochrome data) having high resolution. The above explanation is explanation of a basic principle of the image-quality improving processing. In particular, the explanation is suitable when a correlation between luminance data and color data is arranged generally on one straight line. However, in actual image data, a correlation between luminance data and color data may not be arranged on a straight line.

Generalized processing of the image-quality improving processing is explained below.

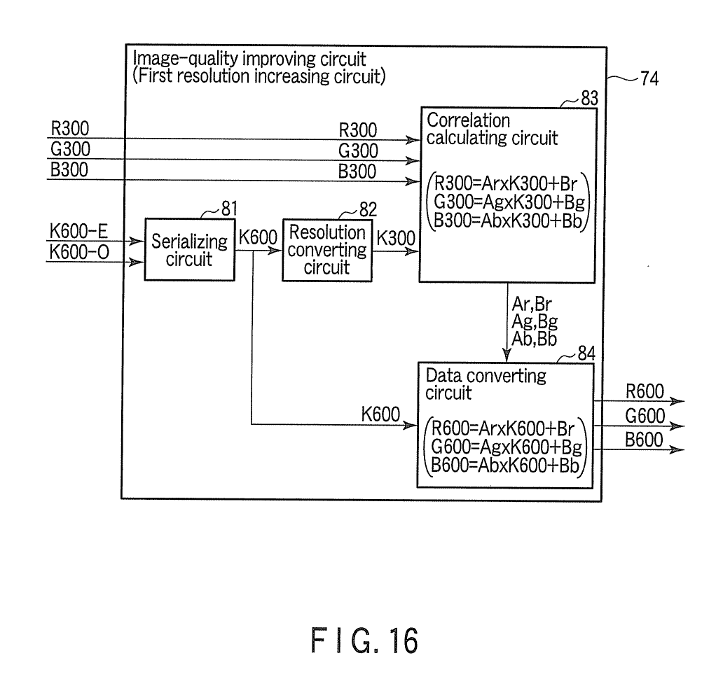

FIG. 16 is a block diagram of processing in the image-quality improving circuit 74.

In a configuration example shown in FIG. 16, the image-quality improving circuit 74 includes a serializing circuit 81, a resolution converting circuit 82, a correlation calculating circuit 83, and a data converting circuit 84.

The image-quality improving circuit 74 is input with 300 dpi R (red) data (R300), 300 dpi G (green) data (G300), 300 dpi B (blue) data (B300), luminance data of even-number-th pixels among 600 dpi pixels (K600-E), and luminance data of odd-number-th pixels among the 600 dpi pixels (K600-O).

The serializing circuit 81 converts the even-number-th luminance data (K600-E) and the odd-number-th luminance data (K600-O) into luminance data (K600), which is serial data. The serializing circuit 81 outputs the serialized luminance data (K600) to the resolution converting circuit 82 and the data converting circuit 84.

The resolution converting circuit 82 converts the 600 dpi luminance data (K600) into 300 dpi luminance data (K300). The resolution converting circuit 82 converts the resolution of 600 dpi into the resolution of 300 dpi. The resolution converting circuit 82 associates pixels of the 600 dpi luminance data (K600) and pixels of the 300 dpi color data. As explained above, the pixels of the 300 dpi color data correspond to the 2×2 pixel matrix including the pixels of the 600 dpi luminance data (K600). The resolution converting circuit 82 calculates an average (luminance data equivalent to 300 dpi (K300)) of the luminance data of 2×2 pixels forming the matrix corresponding to the pixels of the color data.

The correlation calculating circuit 83 is input with R300, G300, B300, and K300. The correlation calculating circuit 83 calculates a regression line of R300 and K300, a regression line of G300 and K300, and a regression line of B300 and K300. The regression lines are represented by the following formulas:

R300=Ar×K300+Br (KR-2)

G300=Ag×K300+Bg (KG-2)

B300=Ab×K300+Bb (KB-2)

Ar, Ag, and Ab represent slopes (constants) of the regression lines and Br, Bg, and Bb represent sections (constants) with respect to the ordinate.

Therefore, the correlation calculating circuit 83 calculates the constants (Ar, AG, Ab, Br, Bg, and Bb) as correlations between the luminance data and the color data. To simplify the explanation, a method of calculating the constants Ar and Br is explained on the basis of the luminance data (K300) and the color data (R300).

First, the correlation calculating circuit 83 sets nine pixels of 3×3 pixels as an area of attention. The correlation calculating circuit 83 calculates a correlation coefficient in the area of attention including the nine pixels. Luminance data and color data for the pixels in the area of attention of 3×3 pixels are represented as Kij and Rij. “ij” indicates variables 1 to 3. For example, R300(2,2) is represented as R22. When an average of K data (K300) of the area of attention is represented as Kave and an average of R data of the area of attention is represented as Rave, the correlation calculating circuit 83 calculates a correlation coefficient (Cr) of the K data and the R data according to the following formula:

$$Cr = \frac{\sum ( ( Kij - K ave ) ( Rij - R ave ) )}{{( \sum {( Kij - K ave )}^{2} )}^{1 / 2} \times {( \sum {( Rij - R ave )}^{2} )}^{1 / 2}}$$

According to this Formula, the correlation coefficient (Cr) is the same as a value obtained by dividing a sum of deviation products by a standard deviation of K and a standard deviation of R. The correlation coefficient (Cr) takes values from −1 to +1. When the correlation coefficient (Cr) is plus, this indicates that the correlation between the K data and the R data is a positive correlation. When the correlation coefficient (Cr) is minus, this indicates that the correlation between the K data and the R data is a negative correlation. The correlation coefficient (Cr) indicates that correlation is stronger as an absolute value thereof is closer to 1.

The correlation calculating circuit 83 calculates the slope (Ar) of the regression line of the luminance data (K) and the color data (R) according to the following formula. In the following formula, the ordinate represents R and the abscissa represents K:

Ar=Cr×((standard deviation of R)/(standard deviation of K))

The correlation calculating circuit 83 calculates a section (Br) according to the following formula:

Section (Br) of R=Rave−(slope×Kave)

The correlation calculating circuit 83 calculates the standard deviation of R and the standard deviation of K according to the following formulas, respectively:

standard deviation of R=(Σ(Rij−Rave)²/9)^{1/2}

standard deviation of K=(Σ(Kij−Kave)²/9)^{1/2}

Concerning the G data and the B data, the correlation calculating circuit 83 calculates slopes Ag and Ab and sections Bg and Bb in regression lines according to a method same as the method explained above. The correlation calculating circuit 83 outputs the calculated constants (Ar, Ag, Ab, Br, Bg, and Bb) to the data converting circuit 84.

The data converting circuit 84 calculates, using luminance data having high resolution, color data having resolution equivalent to that of the luminance data. For example, the data converting circuit 84 calculates 600 dpi color data (R600, G600, and B600) using the 600 dpi luminance data (K600). The data converting circuit 84 calculates R600, G600, and B600 using K600 according to the following formulas including the constants calculated by the correlation calculating circuit 83, respectively:

R600=Ar×K600+Br

G600=Ag×K600+Bg

B600=Ab×K600+Bb

Specifically, the data converting circuit 84 calculates 600 dpi color data (R600, G600, and B600) by substituting the 600 dpi luminance data (K600) in the above formulas, respectively.

The luminance data (K600) substituted in the above formulas is data for four pixels of 600 dpi 2×2 pixels equivalent to a pixel in the center of 300 dpi 3×3 pixels. For example, the luminance data K600 is equivalent to K600(3,3), K600(3,4), K600(4,3), and K600(4,4) shown in FIG. 9. Target pixels for an increase in resolution are R300, G300, and B300(2,2) shown in FIG. 10.

As explained above, the image-quality improving circuit 74 converts, using the data of thirty-six pixels of the 600 dpi luminance data, one 300 dpi pixel located in the center of the nine pixels of the 300 dpi color data into the color data of four 600 dpi pixels. The image-quality improving circuit 74 carries out the processing for all the pixels. As a result, the image-quality improving circuit 74 converts the 300 dpi color data into the 600 dpi color data.

A correlation between the 600 dpi color data obtained as a result of the image-quality improving processing and the 600 dpi monochrome data is equivalent to the correlation between the 300 dpi monochrome data and the 300 dpi color data used for calculating the 600 dpi color data. Specifically, in a processing target range (in this processing example, 9×9 pixels at resolution of 600 dpi and 3×3 pixels at resolution of 300 dpi), when 300 dpi data has positive correlation, 600 dpi data also has positive correlation and, when the 300 dpi data has negative correlation, the 600 dpi data also has negative correlation.

In the image-quality improving processing according to this embodiment, it is possible to increase the resolution of color data having low resolution using luminance data having high resolution without image quality deterioration such as a fall in chroma or color mixture.

The area of attention (the certain range) for calculating a correlation between the luminance data and the color data is not limited to the area of 3×3 pixels and can be selected as appropriate. For example, as an area for calculating a correlation between the luminance data and the color data, an area of 5×5 pixels, 4×4 pixels, or the like may be applied. Resolutions of the color data and the luminance data to which the image-quality improving processing is applied are not limited to 300 dpi and 600 dpi, respectively. For example, the color data may have resolution of 200 dpi and the luminance data may have resolution of 400 dpi or the color data may have resolution of 600 dpi and the luminance data may have resolution of 1200 dpi.

According to the image-quality improving processing explained above, it is possible to obtain color image data having high resolution without deteriorating an S/N ratio of a color signal. If the image-quality improving processing is used, even when a monochrome image (luminance data) having high resolution is read by a luminance sensor having high sensitivity and a color image having resolution lower than that of the luminance sensor is read by a color sensor having low sensitivity, it is possible to increase the resolution of the color image to resolution equivalent to the resolution of the luminance sensor. As a result, it is possible to read the color image having high resolution at high speed. Even if an illumination light source used for reading the color image having high resolution has low power, it is easy to secure reading speed, resolution, and an S/N ratio. The number of data output from a CCD sensor can be reduced.

In the image-quality improving processing, color data is calculated with reference to K data using, for example, a correlation between plural K data and plural color data in a 300 dpi 3×3 pixel matrix. An effect that high-frequency noise is reduced can be obtained by calculating, using the data of the nine pixels in this way, color data of one pixel (four pixels at 600 dpi) in the center of the pixels. Usually, some noise (white noise) is carried on output of the CCD sensor. It is not easy to reduce the noise. In the image-quality improving processing, on the basis of a correlation between the nine pixels of the K data and the nine pixels of the color data, an image quality of data of one pixel located in the center of the pixels is improved.

Therefore, in the image-quality improving processing, even if unexpected noise is superimposed on one read pixel, it is possible to reduce the influence of the noise. According to an experiment, an effect of reducing high-frequency noise in reading an original document having uniform density to about a half to one third is obtained. Such an effect is useful in improving a compression ratio in compressing a scan image. In other words, the image-quality improving processing is not only useful for increasing resolution but also useful as noise reduction processing.

The image-quality improving processing reduces color drift caused by, for example, a mechanism for reading an image. For example, in the mechanism for reading an image, it is likely that color drift is caused by vibration, jitter, and chromatic aberration of a lens. In an image reading apparatus in which R, G, and B color line sensors independently read an image and independently output data of the image, in order to prevent color drift using a physical structure, it is necessary to improve the accuracy of a mechanism system or adopt a lens without aberration. In the image-quality improving processing, all color data are calculated with reference to luminance data. Therefore, in the image-quality improving processing, phase shift of the color data due to jitter, vibration, and chromatic aberration is also corrected. This is also an effect obtained by calculating data of pixels in an area of attention from a correlation among plural image data.

As explained above, in the image reading apparatus, when it is unnecessary to increase the resolution of the color data or even when the resolution of the luminance sensor and the resolution of the color sensor are the same, it is possible to correct a read image to a high-quality image without phase shift by applying the image-quality improving processing to the image. Such correction processing can be realized by a circuit configuration shown in FIG. 16 (the resolution converting circuit 82 is omitted when resolution conversion is unnecessary). As a result of the correction processing, the image forming apparatus can acquire a high-quality read image with less noise and perform high-quality copying. Since the image reading apparatus and the image forming apparatus obtain high-quality image data with image processing, it is possible to hold down power consumption.

Second image-quality improving processing is explained.

The second image-quality improving processing explained below is another example of the image-quality improving processing by the image-quality improving circuit 74.

An image of an original document to be read may include an image of a frequency component close to reading resolution (300 dpi) of color image data. When reading resolution (a sampling frequency) and a frequency component included in an image to be read are close to each other, interference fringes called moiré may occur in image data obtained as a reading result. For example, when a monochrome pattern image in a certain period (e.g., 150 patterns per inch) (hereinafter also referred to as an image having the number of lines near 150) is read by a 300 dpi color sensor, it is likely that an image of a striped pattern (moiré) occurs in 300 dpi color image data.

The image of the striped pattern (moiré) is caused when an area in which a pixel value substantially changes (fluctuates) and an area in which a pixel value hardly changes (is uniform) periodically appear according to a positional relation between light receiving elements in a color sensor and a monochrome pattern to be read. However, when the image having the number of lines near 150 is read by a 600 dpi monochrome sensor, moiré does not occur in 600 dpi monochrome image data. When the 600 dpi monochrome image data is converted into monochrome image data having 300 dpi, moiré occurs in the 300 dpi monochrome image data as in the 300 dpi color image data.

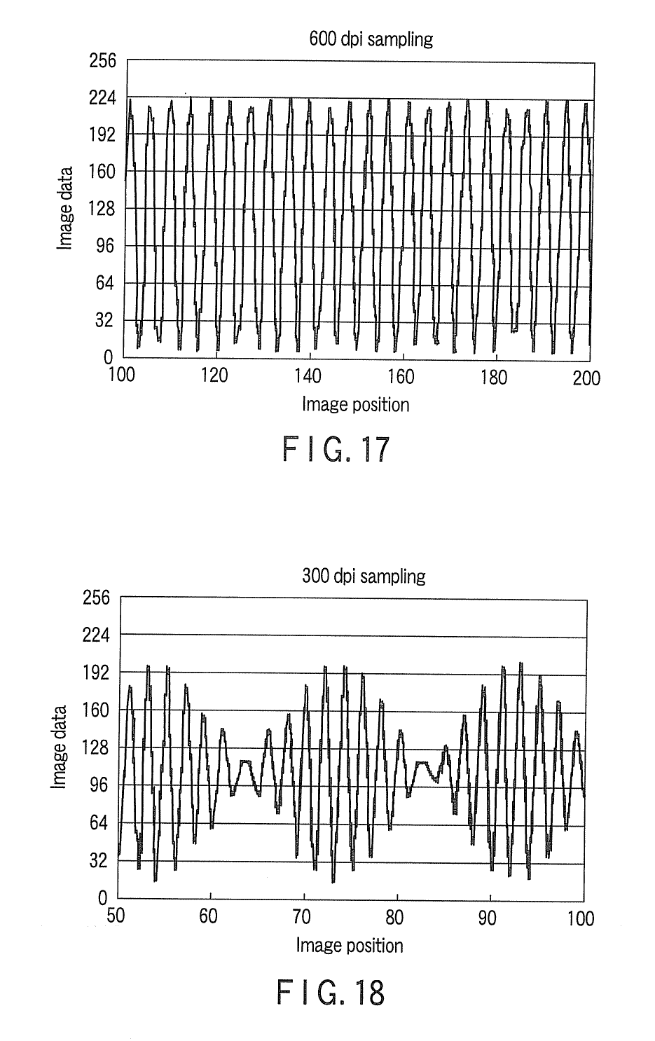

FIG. 17 is a diagram of a profile of image data obtained when the image having the number of lines near 150 is read at resolution of 600 dpi. FIG. 18 is a diagram of a profile of image data obtained when the image data shown in FIG. 17 is converted into 300 dpi image data. In FIGS. 17 and 18, the abscissa represents positions of pixels and the ordinate represents values of the pixels (e.g., 0 to 255).

In FIG. 18, a scale of positions of the pixels (a scale of the abscissa) is twice as large as that in FIG. 17. In the main scanning direction or the sub-scanning direction, the number of pixels at 600 dpi is twice as large as the number of pixels at 300 dpi. Therefore, a numerical value half as large as a pixel position at 600 dpi shown in FIG. 18 is equivalent to a pixel position at 300 dpi shown in FIG. 17.

As shown in FIG. 17, the 600 dpi image data can be resolved in the entire area (contrast can be obtained). On the other hand, as shown in FIG. 18, in the 300 dpi image data, a portion to be resolved (a portion with contrast, i.e., a portion with response) and a portion not to be resolved (a portion without contrast, i.e., a portion without response) periodically appear. A change in resolution (a change in contrast, i.e., a change in responsiveness) that occurs periodically in this way appears as moiré.

When the moiré occurs, a portion not having a change and not to be resolved (without contrast, i.e., without response) is present in the 300 dpi image data. To form the regression line shown in FIG. 14, pixel values in image data need to fluctuate (disperse). When there is no change in image data, it is difficult to generate the regression line shown in FIG. 14. Specifically, when there is moiré in the 300 dpi color image data, it is difficult to generate a straight line indicating a correlation between color data and luminance data. When a slight change is grasped to generate a regression line indicating a correlation, the slope of the regression line substantially changes with a slight change in data. As a result, the regression line is in an unstable state.

In the unstable state, the slope of the regression line substantially changes according to a slight change in image data due to an external factor such as vibration (jitter) caused by movement of an original document during reading or movement of a carriage. In image-quality improving processing performed by using the regression line calculated in the unstable state, irregularity occurs in an image. For example, in the image-quality improving processing performed by using the regression line calculated in the unstable state, it is likely that, at a period in which moiré occurs, various colors occur in an image that should be monochrome (achromatic).

In the second image-quality improving processing, in order to prevent the phenomenon explained above, it is checked whether an image in an area of attention has a frequency component that causes moiré (e.g., a frequency component having the number of lines near 150). When the image in the area of attention does not include the frequency component that causes moiré, in the second image-quality improving processing, image-quality improving processing by the circuit shown in FIG. 16 is performed as first resolution increasing processing. When the image in the area of attention includes the frequency component that causes moiré, in the second image-quality improving processing, second resolution increasing processing different from the first resolution increasing processing is performed.

A second image-quality improving circuit 101 that performs the second image-quality improving processing is explained.

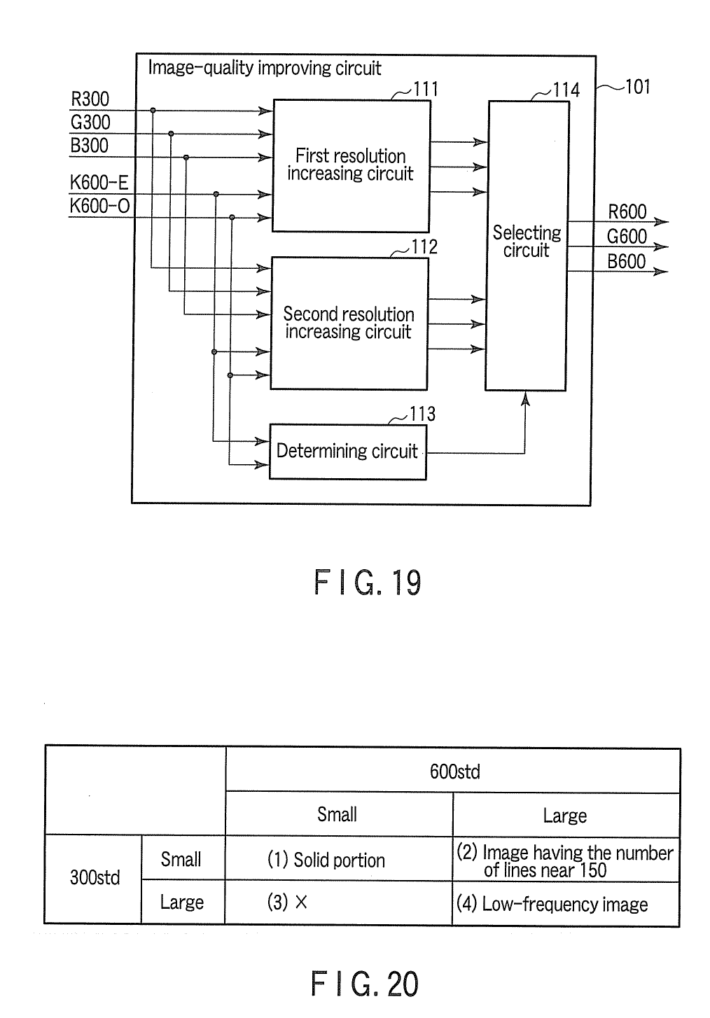

FIG. 19 is a block diagram of a configuration example of the second image-quality improving circuit 101. In the configuration in the scanner-image processing unit 70 shown in FIG. 8, the second image-quality improving circuit 101 is applied instead of the image-quality improving circuit 74.

As shown in FIG. 19, the second image-quality improving circuit 101 includes a first resolution increasing circuit 111, a second resolution increasing circuit 112, a determining circuit 113, and a selecting circuit 114.

The first resolution increasing circuit 111 has a configuration same as that of the image-quality improving circuit 74 shown in FIG. 16. As explained above, the first resolution increasing circuit 111 executes processing for increasing the resolution of color data as first resolution increasing processing on the basis of a correlation between color data and monochrome data.

The second resolution increasing circuit 112 increases the resolution of color data with processing (second resolution increasing processing) different from that of the first resolution increasing circuit 111. The second resolution increasing circuit 112 increases the resolution of image data including the frequency component that causes moiré. In other words, the resolution increasing processing by the second resolution increasing circuit 112 is processing also applicable to the image data including the frequency component that causes moiré. For example, the second resolution increasing circuit 112 increases the resolution of the color data by superimposing a high-frequency component of the monochrome data on the color data. The second resolution increasing circuit 112 is explained in detail later.

The determining circuit 113 determines whether an image to be processed has the frequency component that causes moiré (e.g., the frequency component having the number of lines near 150). Determination processing by the determining circuit 113 is explained in detail later. The determining circuit 113 outputs a determination result to the selecting circuit 114. For example, when the determining circuit 113 determines that the image to be processed is not an image having the number of lines near 150, the determining circuit 113 outputs a determination signal to the selecting circuit 114 that selects a processing result of the first resolution increasing circuit 111. When the determining circuit 113 determines that the image to be processed is the image having the number of lines near 150, the determining circuit 113 outputs a determination signal for selecting an output signal from the second resolution increasing circuit 112 to the selecting circuit 114.

The selecting circuit 114 selects, on the basis of the determination result of the determining circuit 113, the processing result of the first resolution increasing circuit 111 or the processing result of the second resolution increasing circuit 112. For example, when the determining circuit 113 determines that the image to be processed does not include the frequency component that causes moiré, the selecting circuit 114 selects the processing result of the first resolution increasing circuit 111. In this case, the selecting circuit 114 outputs the color data, the resolution of which is increased by the first resolution increasing circuit 111, as a processing result of the image-quality improving circuit 101. When the determining circuit 113 determines that the image to be processed includes the frequency component that causes moiré, the selecting circuit 114 selects the processing result of the second resolution increasing circuit 112. In this case, the selecting circuit 114 outputs the color data, the resolution of which is increased by the second resolution increasing circuit 112, as a processing result of the image-quality improving circuit 101.

Determination processing by the determining circuit 113 is explained.

As explained above, in the second image-quality improving processing, it is checked whether the image in the area of attention has the frequency component that causes moiré (e.g., the image having the number of lines near 150). The determining circuit 113 checks (determines), according to a method explained later, whether the image in the area of attention includes the frequency component that causes moiré.

The determining circuit 113 calculates a standard deviation (a degree of fluctuation) of luminance data (K data) as 600 dpi monochrome image data. As in the processing explained above, the determining circuit 113 calculates the standard deviation in a 6×6 pixel matrix (i.e., thirty-six pixels) in the 600 dpi luminance data (K600). A standard deviation of the 600 dpi luminance data is set to 600 std.

The determining circuit 113 converts the 600 dpi luminance data into 300 dpi luminance data. As a standard deviation of the 300 dpi luminance data after the conversion, the determining circuit 113 calculates a standard deviation of a 3×3 pixel matrix (i.e., nine pixels) in an area equivalent to the 6×6 pixel matrix in the 600 dpi luminance data (K600). A standard deviation of the 300 dpi luminance data is set to 300 std.

In general, a standard deviation is an index indicating a state of fluctuation of data. Therefore, the determining circuit 113 obtains the following information on the basis of the standard deviation (600 std) for the 600 dpi luminance data and the standard deviation (300 std) for the 300 dpi luminance data.
(1) When both 600 std and 300 std are small, the image is a solid image portion without a density change. For example, in an image area without a change in color or luminance such as a white base or a solid black, there is no change in both the 600 dpi image data and the 300 dpi image data. Therefore, both the standard deviations of the luminance data are small values.
(2) When 600 std is large and 300 std is small, the image is an image including a component that causes moiré (an image having the number of lines near 150).
(3) It is normally impossible that 600 std is small and 300 std is large.
(4) When both 600 std and 300 std are large, the image is a low-frequency image that can be sufficiently read at 300 dpi.

FIG. 20 is a table of determination contents corresponding to combinations of 600 std and 300 std explained above.

The determining circuit 113 determines whether the image to be processed is the image including the frequency component that causes moiré (i.e., the image having the number of lines near 150). In an example shown in FIG. 20, when 600 std is large and 300 std is small, the determining circuit 113 determines that the image to be processed is the image having the number of lines near 150. Therefore, the determining circuit 113 determines whether 600 std is large and 300 std is small. Actually, as a determination reference, levels of 600 std and 300 std are set in quantitative values in the determining circuit 113.

In the determining circuit 113, a determination reference value α for 300 std/600 std is set as a determination reference. The determining circuit 113 determines whether a value of 300 std/600 std is equal to or smaller than the determination reference value α (300 std/600 std≦α). A value of “300 std/600 std” is smaller as 600 std is relatively large with respect to 300 std (as 600 std is larger or 300 std is smaller). In other words, it is determined that, as the value of “300 std/600 std” is smaller, the image to be processed is more likely to be the image including the frequency component that causes moiré (i.e., the image having the number of lines near 150). Therefore, if 300 std/600 std≦α, the determining circuit 113 determines that the image to be processed is likely to be the image having the number of lines near 150. According to an experiment, it is known that the image having the number of lines near 150 can be satisfactorily extracted by setting a value of α as the determination reference value to a value of about 0.5 to 0.7 (50% to 70%).

The second resolution increasing circuit 112 is explained.

The second resolution increasing circuit 112 increases the resolution of color data by superimposing a high-frequency component of monochrome data on the color data. The second resolution increasing circuit 112 does not perform processing for increasing resolution using a correlation between color data and luminance data. Content of processing for increasing resolution of the second resolution increasing circuit 112 is different from that of the first resolution increasing circuit 111.

FIG. 21 is a block diagram of a configuration example of the second resolution increasing circuit 112.

As shown in FIG. 21, the second resolution increasing circuit 112 includes a serializing circuit 121, a resolution converting circuit 122, a superimposition-rate calculating circuit 123, and a data converting circuit 124.

The serializing circuit 121 converts even-number-th luminance data (K600-E) and odd-number-th luminance data (K600-O) into luminance data (K600), which is serial data. The serializing circuit 121 outputs the serialized luminance data (K600) to the resolution converting circuit 122 and the superimposition-rate calculating circuit 123.

The resolution converting circuit 122 converts 600 dpi luminance data (K600) into 300 dpi luminance data (K300). The resolution converting circuit 122 converts resolution of 600 dpi into resolution of 300 dpi. The resolution converting circuit 122 associates pixels of the 600 dpi luminance data (K600) and pixels of 300 dpi color data. The pixels of the 300 dpi color data correspond to a 2×2 pixel matrix including the pixels of the 600 dpi luminance data (K600). The resolution converting circuit 122 calculates, as luminance data equivalent to 300 dpi (k300), an average of luminance data of 2×2 pixels forming the matrix corresponding to the pixels of the color data.

The superimposition-rate calculating circuit 123 is explained.

The superimposition-rate calculating circuit 123 calculates a rate for superimposing a frequency component of monochrome data on color data.

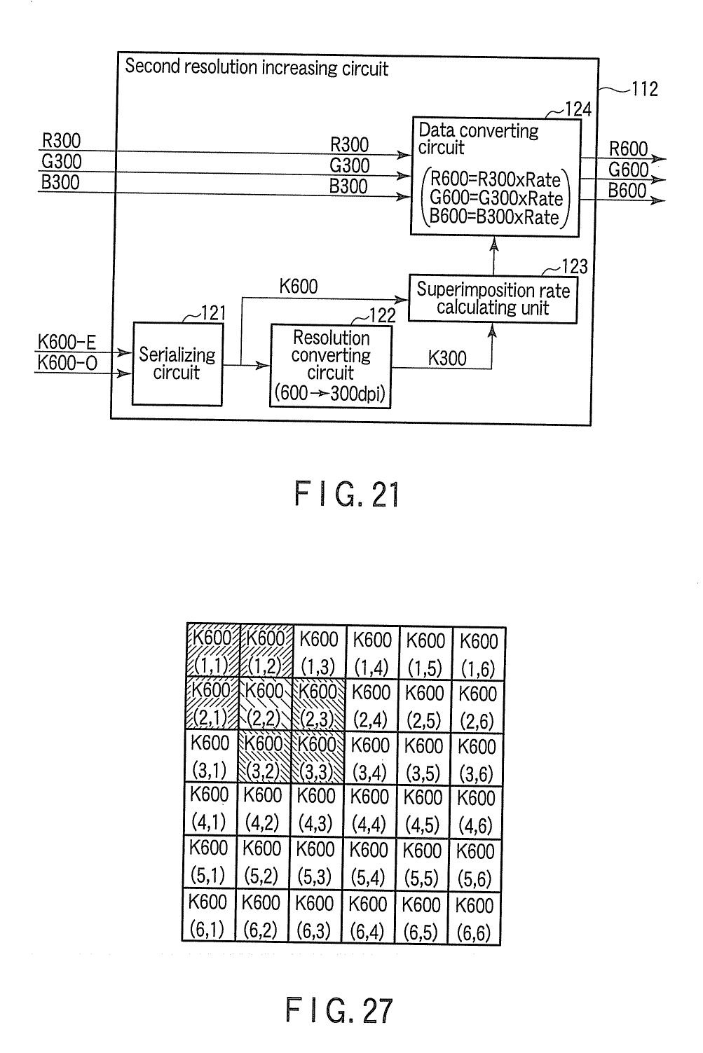

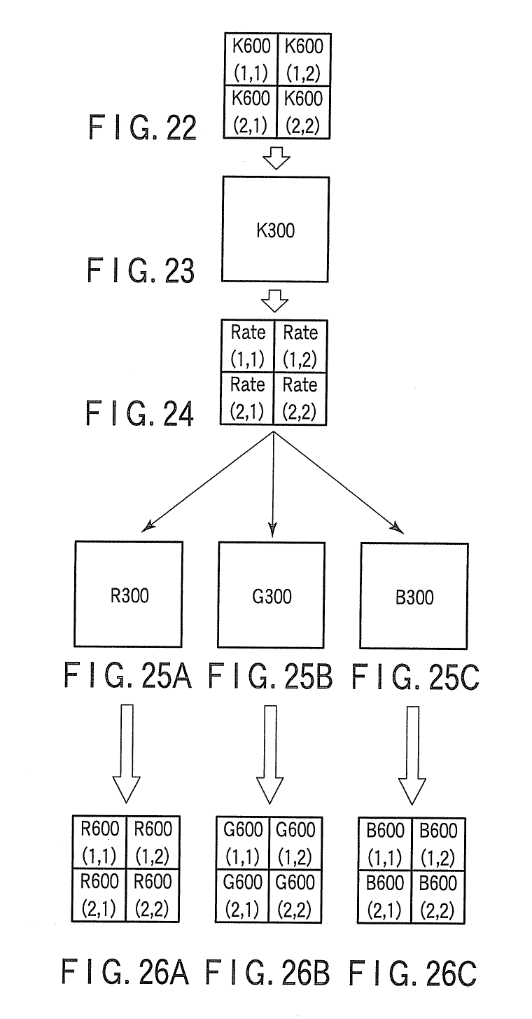

Superimposition rate calculation processing is explained with reference to examples shown in FIGS. 22 to 24. FIG. 22 is a diagram of an example of 600 dpi luminance (monochrome) data forming a 2×2 pixel matrix. FIG. 23 is an example of 300 dpi luminance data (or color data) corresponding to the 2×2 pixel matrix shown in FIG. 22. FIG. 24 is a diagram of an example of superimposition rates in 600 dpi pixels.

The superimposition-rate calculating circuit 123 extracts four pixels (a 2×2 pixel matrix) in 600 dpi monochrome data corresponding to one 300 dpi pixel. For example, the superimposition-rate calculating circuit 123 extracts the 600 dpi luminance data for the four pixels forming the 2×2 pixel matrix shown in FIG. 22 in association with one pixel of 300 dpi monochrome data shown in FIG. 23.

The superimposition-rate calculating circuit 123 calculates an average K600ave for the luminance data for the four 600 dpi pixels corresponding to the one 300 dpi pixel. For example, the superimposition-rate calculating circuit 123 calculates the average K600ave according to the following formula:

K600ave=(K600(1,1)+K600(1,2)+K600(2,1)+K600(2,2))/4

After calculating the average K600ave, the superimposition-rate calculating circuit 123 calculates a rate of change Rate(*,*) for the average K600ave of pixels (*,*) In other words, rates of change of the 600 dpi pixels indicate contrast ratios of the pixels to an area of attention (the 2×2 pixel matrix). For example, the superimposition-rate calculating circuit 123 calculates rates of change Rate(1,1), (1,2), (2,1), and (2,2) in K600(1,1), (1,2), (2,1), and (2,2) according to the following formulas:

Rate(1,1)=K600(1,1)/K600ave

Rate(1,2)=K600(1,2)/K600ave

Rate(2,1)=K600(2,1)/K600ave

Rate(2,2)=K600(2,2)/K600ave

The superimposition-rate calculating circuit 123 outputs rates of change Rate(*,*) corresponding to the 600 dpi pixels K600(*,*) calculated by the procedure explained above to the data converting circuit 124.

The data converting circuit 124 multiplies the 300 dpi color data corresponding to the pixels equivalent to 600 dpi with the rates of change corresponding to the pixels input from the superimposition-rate calculating circuit 123. FIGS. 25A, 25B, and 25C are diagrams of examples of R data (R300), G data (G300), and B data (B300) as 300 dpi color data. FIGS. 26A, 26B, and 26C are diagrams of examples of R data (R600), G data (G600), and B data (B600) equivalent to 600 dpi generated from the 300 dpi color data shown in FIGS. 25A, 25B, and 25C.

For example, the data converting circuit 124 calculates the R data (R600) equivalent to 600 dpi by multiplying R300 with the rates of change corresponding to the pixels equivalent to 600 dpi as indicated by the following formulas:

R600(1,1)=R300*Rate(1,1)

R600(1,2)=R300*Rate(1,2)

R600(2,1)=R300*Rate(2,1)

R600(2,2)=R300*Rate(2,2)

According to such superimposition processing, the data converting circuit 124 converts R300 shown in FIG. 25A into R600 shown in FIG. 26A.

The data converting circuit 124 calculates G data (G600) equivalent to 600 dpi by multiplying G300 with rates of change corresponding to the pixels equivalent to 600 dpi as indicated by the following formulas:

G600(1,1)=G300*Rate(1,1)

G600(1,2)=G300*Rate(1,2)

G600(2,1)=G300*Rate(2,1)

G600(2,2)=G300*Rate(2,2)

According to such superimposition processing, the data converting circuit 124 converts B300 shown in FIG. 25B into G600 shown in FIG. 26B.

The data converting circuit 124 calculates B data (B600) equivalent to 600 dpi by multiplying B300 with rates of change corresponding to pixels equivalent to 600 dpi as indicated by the following formulas:

B600(1,1)=B300*Rate(1,1)

B600(1,2)=B300*Rate(1,2)

B600(2,1)=B300*Rate(2,1)

B600(2,2)=B300*Rate(2,2)

According to such superimposition processing, the data converting circuit 124 converts B300 shown in FIG. 25C into B600 shown in FIG. 26C.

As explained above, the image-quality improving circuit 101 is input with high-resolution monochrome data and low-resolution color data. The image-quality improving circuit 101 includes the first resolution increasing circuit 111 that performs the first resolution increasing processing for increasing the resolution of the color data on the basis of a correlation between the color data and the monochrome data and the second resolution increasing circuit 112 that performs the second resolution increasing processing for increasing the resolution of the color data by superimposing a high-frequency component of the monochrome data on the color data. The image-quality improving circuit 101 outputs a processing result of the second resolution increasing circuit 112 when an image to be processed is an image having a component close to a frequency component that causes moiré at the resolution of the input color data and outputs a processing result of the first resolution increasing circuit 111 when the image to be processed is other images. Such an image-quality improving circuit 101 can output satisfactory high-resolution image data regardless of what kind of image an image of an original document is.

In the processing example explained above, the processing closed in the four 600 dpi pixels corresponding to the one 300 dpi pixel is explained. However, if the image-quality improving processing is performed for each of the four 600 dpi pixels (one 300 dpi pixel), it is likely that continuity among adjacent pixels falls in the entire image. In order to secure continuity among the adjacent pixels in the entire image, it is preferable to execute the image-quality improving processing for the second time after phase-shifting an image area to be processed (an area of attention) by one pixel. For example, the second image-quality improving processing, an image area to be processed (a 2×2 pixel matrix) in 600 dpi image data is set while being phase-shifted by one pixel. In 600 dpi color image data as a result of such re-processing, continuity among adjacent pixels is secured.

FIG. 27 is a diagram for explaining the image-quality improving processing for securing continuity among adjacent pixels.

First, the image-quality improving circuit 74 or the image-quality improving circuit 101 sets four pixels (a 2×2 pixel matrix) of K600(1,1), K600(1,2), K600(2,1), and K600(2,2) as image area to be processed (a first area of attention). In this case, the image-quality improving circuit 74 or 101 increases the resolution of color data (R300, G300, and B300) corresponding to the first area of attention. As a result of the processing, the image-quality improving circuit 74 or 101 obtains 600 dpi color image data R600(1,1), R600(1,2), R600(2,1), R600(2,2), G600(1,1), G600(1,2), G600(2,1), G600(2,2), B600(1,1), B600(1,2), B600(2,1), and B600(2,2).

The image-quality improving circuit 74 or 101 performs the image-quality improving processing in an entire image with the four pixels (the 2×2 pixel matrix) corresponding to 300 dpi color data set as the image area to be processed (the first area of attention) in order. The image-quality improving circuit 74 or 101 obtains 600 dpi color data for the entire image including 600 dpi color data generated for each image area to be processed (the first area of attention).

After generating the 600 dpi color data in the entire image area, the image-quality improving circuit 74 or 101 performs processing for improving continuity among adjacent pixels. As the processing for improving continuity among adjacent pixels, the image-quality improving circuit 74 or 101 sets an area phase-shifted by one pixel from the first area of attention as an image area to be processed for the second time (a second area of attention). The image-quality improving circuit 74 or 101 applies the second image-quality improving processing to the image area to be processed for the second time.

For example, as shown in FIG. 27, the image-quality improving circuit 74 or 101 sets, as the second area of attention (a target area of the second image-quality improving processing) phase-shifted from the first area of attention by one pixel, four pixels (a 2×2 pixel matrix) of K600(2,2), K600(2,3), K600(3,2), and K600(3,3). In this case, the image-quality improving circuit 74 or 101 converts 600 dpi color data for four pixels {R600(2,2), R600(2,3), R600(3,2), and R600(3,3)} corresponding to the second area of attention in the 600 dpi color data generated in the processing explained above into 300 dpi color data (R300′). Processing for converting R600 for four pixels into R300′ is the same as, for example, the processing by the resolution converting circuits 82 and 122.

After calculating R300′ corresponding to the second area of attention, the image-quality improving circuit 74 or 101 increases the resolution of R300′ for the second time with luminance data for four pixels of the second area of attention {K600(2,2), K600(2,3), K600(3,2), and K600(3,3)}. Specifically, the image-quality improving circuit 74 or 101 calculates R600(2,2), R600(2,3), R600(3,2), and R600(3,3) for the second time with luminance data for four pixels (K600) in the second area of attention and R300′ corresponding to the second area of attention.

The image-quality improving circuit 74 or 101 also applies the processing for the second area of attention to G data and B data. According to such processing, the image-quality improving circuit 74 or 101 can impart continuity among adjacent pixels in the entire image data increased in resolution.

Additional advantages and modifications will readily occur to those skilled the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image reading apparatus comprising:
a first photoelectric conversion unit that converts an image of an original document into an electric signal at first resolution;
a second photoelectric conversion unit that converts the image of the original document into an electric signal at second resolution higher than the first resolution; and
an image-quality improving unit that is input with first image data obtained by reading the image of the original document at the first resolution with the first photoelectric conversion unit and second image data obtained by reading the image of the original document at the second resolution with the second photoelectric conversion unit, outputs, if a correlation between the first image data and the second image data is positive correlation, third image data obtained by converting the first resolution of the first image data into the second resolution and having positive correlation as a correlation with the first image data, and outputs, if the correlation between the first image data and the second image data is negative correlation, third image data obtained by converting the first resolution of the first image data into the second resolution and having negative correlation as a correlation with the first image data.

2. The apparatus according to claim 1, wherein
the first photoelectric conversion unit converts light in a wavelength range corresponding to a certain color into an electric signal at the first resolution, and
the second photoelectric conversion unit converts light in a wavelength range larger than the wavelength range corresponding to the color into an electric signal at the second resolution.

3. The apparatus according to claim 1, wherein
the first photoelectric conversion unit includes three color line sensors including optical filters equivalent to three colors for representing colors; and
the second photoelectric conversion unit includes a monochrome line sensor in which a filter for limiting a wavelength range of light is not provided.

4. The apparatus according to claim 3, wherein the three color line sensors and the monochrome line sensor are integrally formed.

5. The apparatus according to claim 1, wherein the second resolution is twice as high as the first resolution.

6. The apparatus according to claim 1, wherein the image-quality improving unit determines a correlation between the first image data and the second image data for each of image areas to be processed and converts the first image data into the third image data having the second resolution on the basis of the correlation determined for each of the image area to be processed.

7. The apparatus according to claim 1, wherein the image-quality improving unit converts the second image data into fourth image data having the first resolution and determines the correlation according to the fourth image data and the first image data.

8. The apparatus according to claim 7, wherein a correlation between the first image data and the fourth image data is equivalent to a correlation between the second image data and the third image data.

9. The apparatus according to claim 1, wherein the correlation is a linear function.

10. The apparatus according to claim 1, wherein the image-quality improving unit converts, if an image of a frequency components that causes moiré at the first resolution is included in an image area to be processed, the first image data into the third image data according to a contrast ratio of the second image data to a fourth image data obtained by converting the second resolution of the second image data into the first resolution and converts, if the image of the frequency component that causes moiré at the first resolution is not included in the image area to be processed, the second image data into the third image data on the basis of a correlation between the fourth image data and the first image data.

11. The apparatus according to claim 10, wherein the image-quality improving unit determines, according to a ratio of a standard deviation of pixel values in the second image data and a standard deviation of pixel values in the fourth image data, whether the image area to be processed includes the image of the frequency component that causes moiré at the first resolution.

12. An image reading apparatus comprising:
a first photoelectric conversion unit that has sensitivity to a first wavelength range;
a second photoelectric conversion unit that has sensitivity to a wavelength range including the first wavelength range and wider than the first wavelength range; and
an image-quality improving unit that is input with first image data obtained by reading an image of an original document with the first photoelectric conversion unit and second image data obtained by reading the image of the original document with the second photoelectric conversion unit, outputs, if a correlation between the first image data and the second image data is positive correlation, third image data having positive correlation as a correlation with the first image data, and outputs, if the correlation between the first image data and the second image data is negative correlation, third image data having negative correlation as a correlation with the first image data.

13. The apparatus according to claim 12, wherein the image-quality improving unit determines a correlation between the first image data and the second image data for each of image areas to be processed and outputs the third image data obtained by correcting the first image data on the basis of the correlation determined for each of the image areas to be processed.

14. An image forming apparatus comprising:
a first photoelectric conversion unit that converts an image of an original document into an electric signal at first resolution;
a second photoelectric conversion unit that converts the image of the original document into an electric signal at second resolution higher than the first resolution;
an image-quality improving unit that is input with first image data obtained by reading the image of the original document at the first resolution with the first photoelectric conversion unit and second image data obtained by reading the image of the original document at the second resolution with the second photoelectric conversion unit, outputs, if a correlation between the first image data and the second image data is positive correlation, third image data obtained by converting the first resolution of the first image data into the second resolution and having positive correlation as a correlation with the first image data, and outputs, if the correlation between the first image data and the second image data is negative correlation, third image data obtained by converting the first resolution of the first image data into the second resolution and having negative correlation as a correlation with the first image data; and
an image forming unit that forms the third image data generated by the image-quality improving unit on an image forming medium.

15. The apparatus according to claim 14, wherein the image-quality improving unit determines a correlation between the first image data and the second image data for each of image areas to be processed and converts the first image data into the third image data having the second resolution on the basis of the correlation determined for each of the image area to be processed.

16. The apparatus according to claim 14, wherein the image-quality improving unit converts the second image data into fourth image data having the first resolution and determines the correlation according to the fourth image data and the first image data.

17. The apparatus according to claim 16, wherein a correlation between the first image data and the fourth image data is equivalent to a correlation between the second image data and the third image data.

18. The apparatus according to claim 14, wherein the image-quality improving unit converts, if an image of a frequency components that causes moiré at the first resolution is included in an image area to be processed, the first image data into the third image data according to a contrast ratio of the second image data to a forth image data obtained by converting the second resolution of the second image data into the first resolution and converts, if the image of the frequency component that causes moiré at the first resolution is not included in the image area to be processed, the second image data into the third image data on the basis of a correlation between the fourth image data and the first image data.

19. An image forming apparatus comprising:
a first photoelectric conversion unit that has sensitivity to a first wavelength range;
a second photoelectric conversion unit that has sensitivity to a wavelength range including the first wavelength range and wider than the first wavelength range;
an image-quality improving unit that is input with first image data obtained by reading an image of an original document with the first photoelectric conversion unit and second image data obtained by reading the image of the original document with the second photoelectric conversion unit, outputs, if a correlation between the first image data and the second image data is positive correlation, third image data having positive correlation as a correlation with the first image data, and outputs, if the correlation between the first image data and the second image data is negative correlation, third image data having negative correlation as a correlation with the first image data; and
an image forming unit that forms the third image data generated by the image-quality improving unit on an image forming medium.

20. The apparatus according to claim 19, wherein the image-quality improving unit determines a correlation between the first image data and the second image data for each of image areas to be processed and outputs the third image data obtained by correcting the first image data on the basis of the correlation determined for each of the image areas to be processed.
